(19) United States
(12) Patent Application Publication
(10) Pub. No.: US 2013/0072223 A1
(43) Pub. Date: Mar. 21, 2013

(54) LOCATION-BASED DECISION MAKING FOR ASSET TRACKING DEVICES

(71) Applicants: Paul Berenberg, Mountain View, CA (US); Suren Baghdasaryan, San Jose, CA (US)

(72) Inventors: Paul Berenberg, Mountain View, CA (US); Suren Baghdasaryan, San Jose, CA (US)

(73) Assignee: Cubic Corporation, San Diego, CA (US)

(21) Appl. No.: 13/553,466

(22) Filed: Jul. 19, 2012

Related U.S. Application Data
(60) Provisional application No. 61/535,055, filed on Sep. 15, 2011.

(51) Int. Cl. H04W 4/02; G06F 17/30

(52) U.S. Cl. 455/456.1; 707/736; 707/E17.018

(57) ABSTRACT

A method of creating geographic zones may include receiving a selection of a first geographic zone located at least partially within a geographic region, storing a tree data structure that represents the first geographic zone, and sending the tree data structure to be stored on one or more asset tracking devices. The tree data structure may include a plurality of nodes organized into parent-child relationships where each of the nodes represents geographic areas. A root node may represent the geographic region, each child node may represent a sub-area of a geographic area represented by the respective parent node, each node may represent a geographic area that at least partially overlaps with the first geographic zone, and each node representing a geographic area that is entirely within the first geographic zone may include an identifier associated with the first geographic zone.

### BACKGROUND

Modern networks can comprise a variety of devices, which may be connected in a variety of ways. A network can be, for example, centralized or ad hoc. In the latter case, each networked device, or node, can act as a router to forward data from other nodes, in addition to communicating its own data. These wireless networks, however, have their limitations. For example, wireless devices powered by batteries may require frequent battery changes due to the high power cost of wireless data transmission. Because of maintenance issues, among other things, ad hoc wireless networks may not be used in various applications for which the networks might otherwise be suitable.

One particularly useful application of wireless networks involves asset tracking devices. These devices may be attached to, or otherwise code located with, various assets that may travel throughout a geographic region. Asset tracking devices may be used in military settings, commercial transportation, shipping containers, and many other similar applications. However, due to a number of factors, many devices are unable to engage in otherwise desirable operations.

### BRIEF SUMMARY

In one embodiment, a method of creating geographic zones within a geographic region for influencing the operations of one or more asset tracking devices that can be remotely located within the geographic region is presented. The method may include receiving, through an interface, a selection of a first geographic zone located at least partially within the geographic region, storing a tree data structure that represents the first geographic zone, and sending the tree data structure through a port to be stored on the one or more asset tracking devices. In one embodiment, the tree data structure may include a plurality of nodes where each of the plurality of nodes is organized into a plurality of parent-child relationships, and each of the plurality of nodes represents geographic areas. A root node in the plurality of nodes may represent the geographic region. Each child node in the plurality of parent-child relationships may represent a sub-area of a geographic area represented by the respective parent node. Each node in the plurality of nodes may represent a geographic area that at least partially overlaps with the first geographic zone. Each node in the plurality of nodes representing a geographic area that is entirely within the first geographic zone may include an identifier associated with the first geographic zone.

In another embodiment, a method of influencing the operations of an asset tracking device within a geographic region based on a location of the asset tracking device relative to a first geographic zone located at least partially within the geographic region is presented. The method may include storing a tree data structure that represents the first geographic zone. In one embodiment, the tree data structure may include a plurality of nodes where each of the plurality of nodes is organized into a plurality of parent-child relationships, and each of the plurality of nodes represents geographic areas. A root node in the plurality of nodes may represent the geographic region. Each child node in the plurality of parent-child relationships may represent a sub-area of a geographic area represented by the respective parent node. Each node in the plurality of nodes may represent a geographic area that at least partially overlaps with the first geographic zone. Each node in the plurality of nodes representing a geographic area that is entirely within the first geographic zone may include an identifier associated with the first geographic zone. The method may further include receiving the location of an asset associated with the asset tracking device, and translating the location of the asset into a string of sequential characters. The method may also include sequentially accessing each character in the string of sequential characters to traverse the tree data structure. In one embodiment, a first character may be associated with the root node, the first character may determine which child node, if any, of the root node should be traversed, and each successive character in the string of sequential characters may determine which child node, if any, to traverse at each successive level of the tree data structure. The method may additionally include determining whether any of the traversed nodes include the identifier associated with the first geographic zone and, in response, executing a set of instructions associated with the first geographic zone.

In yet another embodiment, an asset tracking device for determining whether an asset is located within a first geographic zone at least partially within a geographic region is presented. The system may include a location processing device configured to receive a location of the asset, and a memory storing a tree data structure that represents the first geographic zone. In one embodiment, the tree data structure may include a plurality of nodes where each of the plurality of nodes is organized into a plurality of parent-child relationships, and each of the plurality of nodes represents geographic areas. A root node in the plurality of nodes may represent the geographic region. Each child node in the plurality of parent-child relationships may represent a sub-area of a geographic area represented by the respective parent node. Each node in the plurality of nodes may represent a geographic area that at least partially overlaps with the first geographic zone. Each node in the plurality of nodes representing a geographic area that is entirely within the first geographic zone may include an identifier associated with the first geographic zone. The system may further include a processor coupled to an instruction set, which when executed causes the processor to receive the location of an asset associated with the asset tracking device from the location processing device, translate the location of the asset into a string of sequential characters, and sequentially access each character in the string of sequential characters to traverse the tree data structure. In one embodiment, a first character may be associated with the root node, the first character may determine which child node, if any, of the root node should be traversed, and each successive character in the string of sequential characters may determine which child node, if any, to traverse at each successive level of the tree data structure. The instructions may further cause the processor to determine whether any of the traversed nodes include the identifier associated with the first geographic zone and, in response, executing a set of instructions associated with the first geographic zone.

### BRIEF DESCRIPTION OF THE DRAWINGS

FIG. 1A is a block diagram of an embodiment of a wireless network for communicating sensor information.

FIG. 1B is a block diagram of another embodiment of a wireless network for communicating sensor information in which a gateway device is wirelessly connected with the Internet.

FIG. 2 is a block diagram of an embodiment of a gateway device.

FIG. 3A is a block diagram of an embodiment of a wireless sensor device (WSD).

FIG. 4 illustrates a geographic region, according to one embodiment.

FIG. 5 illustrates a flowchart for a method of creating geographic zones within a geographic region for influencing the operations of one or more asset tracking devices that can be remotely located within the geographic region, according to one embodiment.

FIG. 6 illustrates a geographic region that is subdivided into a number of rectangular subareas.

FIG. 7 illustrates defining geographic zones using subdivided rectangular divisions, according to one embodiment.

FIG. 8A illustrates a map with three geographic zones, according to one embodiment.

FIG. 8B illustrates geographic zones that are adjusted to coincide with the rectangular grid, according to one embodiment.

FIG. 9A illustrates a geographic zone, according to one embodiment.

FIG. 9B illustrates one embodiment of a corresponding data structure representing geographic zone from FIG. 9A.

FIG. 10A illustrates a geographic zone subdivided into five rectangular blocks, according to one embodiment.

FIG. 10B illustrates how a data structure may be augmented to represent two geographic zones, according to one embodiment.

FIG. 11 illustrates how a geographic zone may be represented using squares and vertical rectangular blocks, according to one method.

FIG. 12 illustrates a flowchart of a method of influencing the operations of an asset tracking device within a geographic region based on a location of the asset tracking device relative to a first geographic zone located at least partially within the geographic region, according to one embodiment.

FIG. 13 illustrates converting coordinates into a string of sequential characters, according to one embodiment.

FIG. 14 illustrates an example of traversing a data structure representing multiple geographic zones, according to one embodiment.

FIG. 15 illustrates a block diagram illustrating components of an exemplary operating environment in which various embodiments of the present invention may be implemented.

FIG. 16 illustrates a block diagram illustrating an exemplary computer system in which embodiments of the present invention may be implemented.

### DETAILED DESCRIPTION

In the following description, for the purposes of explanation, numerous specific details are set forth in order to provide a thorough understanding of various embodiments. It will be apparent, however, to one skilled in the art that various embodiments may be practiced without some of these specific details. In other instances, well-known structures and devices are shown in block diagram form.

The ensuing description provides exemplary embodiments only and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosed systems and methods as set forth in the appended claims.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, known circuits, processes, algorithms, structures, and techniques may be shown without unnecessary detail in order to avoid obscuring the embodiments.

Also, individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Furthermore, embodiments may be implemented by hardware, software, firmware, middleware, microcode, hardware description languages, or any combination thereof. When implemented in software, firmware, middleware, or microcode, the program code or code segments to perform the necessary tasks may be stored in a machine-readable medium. A processor(s) may perform the necessary tasks.

A scalable methodology is described that can be provided to location aware devices for making fast, actionable decisions based on location. According to some embodiments, for example, it can be advantageous for an autonomous asset tracking device to be able to change its configuration, send reports, silence itself, to be addressed, and many other actions based at least in part on the location of the asset tracking device.

According to some embodiments, actions can be based on the entrance to, or exit from, geographical zones, rather than a point on the map. These zones can be of arbitrary shapes that are not necessarily contiguous. They can be very small, cover the whole world or other geographic region of interest, contain holes or exclusions, and/or overlap, etc. Generally, it can be assumed that the shapes of these zones are unpredictable, the number of zones is unlimited, and the resolution and complexity of these zones is continually growing. Additionally, it may be assumed that the device actions necessary for determining when a device is in a particular zone should be executed within a definitive, limited period of time. If the asset tracking devices are low power, there may also be a need to stay within an allotted power budget and to preferably use a predictable power profile as the number and complexity of geographic zones increases.

Embodiments discussed herein allow devices to make decisions based on location deterministically within a predictable number of operations (which can depend on device implementation) regardless of the number, shape, overlapping boundaries, size, or any other parameter relating to a geographical zone. Methods and systems will be discussed that allow for the efficient determination of whether a device is in a particular geographic zone and provide for specific instructions to be executed by the device in response. Additionally, embodiments discussed herein may enable devices to be addressed based on their location relative to specific geographic zones, a practice commonly known as “geocasting.”

Conventional algorithms have a processing time that depends on a number of areas and their shape, where complexity can be described as O(n) at best. In other words, increasing the number of zones, the complexity of the zones, and/or the resolution used to describe the zones, will proportionally increase the time and processing power it takes to analyze whether a device is inside of a zone. In comparison, the proposed systems and methods discussed below may be described using a complexity of O(log₂(n)).

One commonly used method with a complexity of O(n) is known as the “vector method.” The vector method relies on a list of the geographical zone descriptors, where each zone can be described as the circular set of connected vectors. The determination of belonging to the zone can be based on the current location placed on the map. If a location is not between the highest and the lowest point of any vector in the loop, then the device is determined to be outside of the zone. If the location is between the highest and lowest point, then a line is drawn to the right (or left) from the current location until it reaches the rightmost (or leftmost) point of any of the vectors. If the line crosses the vector loop an even number of times, the location is considered to be outside the zone. If it crosses an odd number of times, then the location is considered to be inside the zone. Besides being somewhat imprecise, the vector method suffers from its O(n) complexity. The vector method requires O(n) computations per area, as the number of intersections is virtually unlimited. Additionally, increasing the number, complexity, and/or resolution of the zones proportionally increases the processing time and resources required for determining whether the device is in a zone.

Another commonly used method for determining whether a device is in a zone is to use a list of geographical zones, with each zone having a limited predetermined, primitive shape, such as a circle, rectangle, and/or combinations of these primitive shapes. A decision making algorithm may then be employed to check each zone in the list. The calculation to check belonging to a zone can be fairly simple; however, it necessarily involves complex floating point operations. Those calculations cannot be simplified without a significant loss of accuracy. Furthermore, these calculations are linear, and have a complexity of O(n). Thus, like the vector method, this method using primitive lists also suffers proportionally as the number, complexity, and/or resolution of the zones increases.

In comparison, the embodiments discussed herein can include one or more of the following advantages. The time for the location-based decision making can become very short, predictable, and limited, regardless of the geographical area properties or numbers. Deterministic decision making enables mission-critical, real-time actions. Significant power saving can be enabled for low power devices. Unprecedented scalability in terms of number of geographical areas for the location based functionality can be realized. Variable shape geographical zones can be supported. Finally, geographic zones may vary widely in complexity, resolution, continuity, size, and/or number while maintaining a predictable power profile for processing on an asset tracking device.

Determining whether an item is in a particular geographic zone may have many applications in many different fields. For example, it may be useful to determine a geographic zone for cell phones, GPS devices, portable computing devices, automobiles, aircraft, trains, ocean vessels, shipping containers, weapons, military personnel, and/or the like. In one particular embodiment, the methods and systems discussed herein may be directed to tracking assets. Specifically, asset tracking devices may be used in a logistical management system to track assets that are being moved between destinations. For example, asset tracking devices may be attached to containers housing manufactured goods en route from storage to retail locations. Other examples may include other types of goods moving between different locations in a supply chain. In many cases, asset tracking devices may be comprised of wireless network devices that communicate through a wireless network.

As used herein, an “asset tracking device” may refer to any electronic device that is used or configured to monitor the location of an item, or “asset.” In many embodiments, asset tracking devices may be implemented using wireless sensor devices that are part of one or more wireless networks. Wireless networks and wireless network devices (including wireless sensor devices (WSDs)) described herein may be configured in a variety of ways and in a variety of contexts. Example configurations include mesh, point-to-point, and/or ad hoc networks, among others. The flexible nature of these networks—enabling network devices, or nodes, to join and leave these networks dynamically—together with WSDs configured to collect and communicate sensor information, enables these networks to provide end-to-end security and management of transportation and/or logistical systems. Although disclosed embodiments focus on wireless technologies, the techniques described herein can be applied to wired communication networks, such as an ad-hoc serial interface, for example.

For example, a wireless network can comprise a plurality of WSDs providing sensor information relating to a plurality of cargo containers located in a depot. The sensor information can include data from a variety of sensors, which can indicate the temperature and/or humidity of a container, whether the container door is or has been opened, whether the container is experiencing or has experienced a shock, the location of the container, whether the container is moving, and more. The wireless network further can include a gateway device that collects the sensor information and provides it to systems outside the wireless network. As WSD-equipped containers enter and leave the depot, the wireless network will adjust accordingly, enabling WSDs of containers entering the depot to join the wireless network while the WSDs of containers leaving the depot are dropped from the wireless network. Furthermore, WSDs can act as routers to relay sensor information from other WSDs that are not in direct communication with the depot's gateway device.

Low-power wireless networks can be advantageous in transportation, logistical, and similar applications where network devices are mobile devices operating on battery power. Although many battery-operated mobile devices utilize wireless technologies, most mobile devices exhaust their batteries in a matter of hours or days. The term “low-power wireless networks” as used herein refers to wireless networks utilizing technologies that enable battery-powered devices to operate for a year or more without exhausting their batteries. This can include technologies associated with the IEEE 802.15.4 and/or ISO/IEC 18000-7 standards, as well as various proprietary technologies, among others.

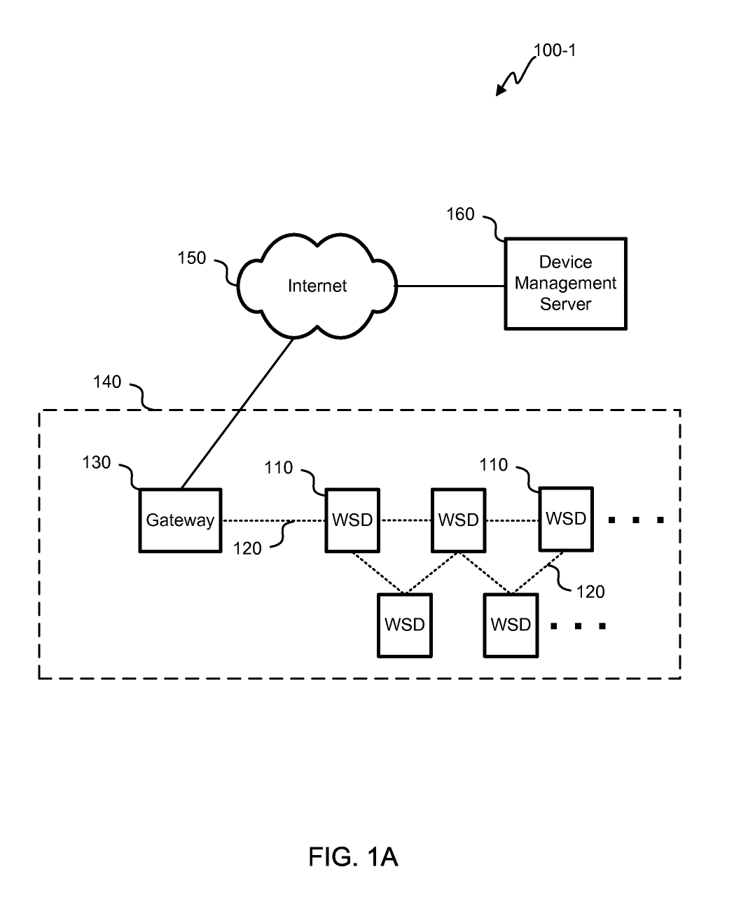

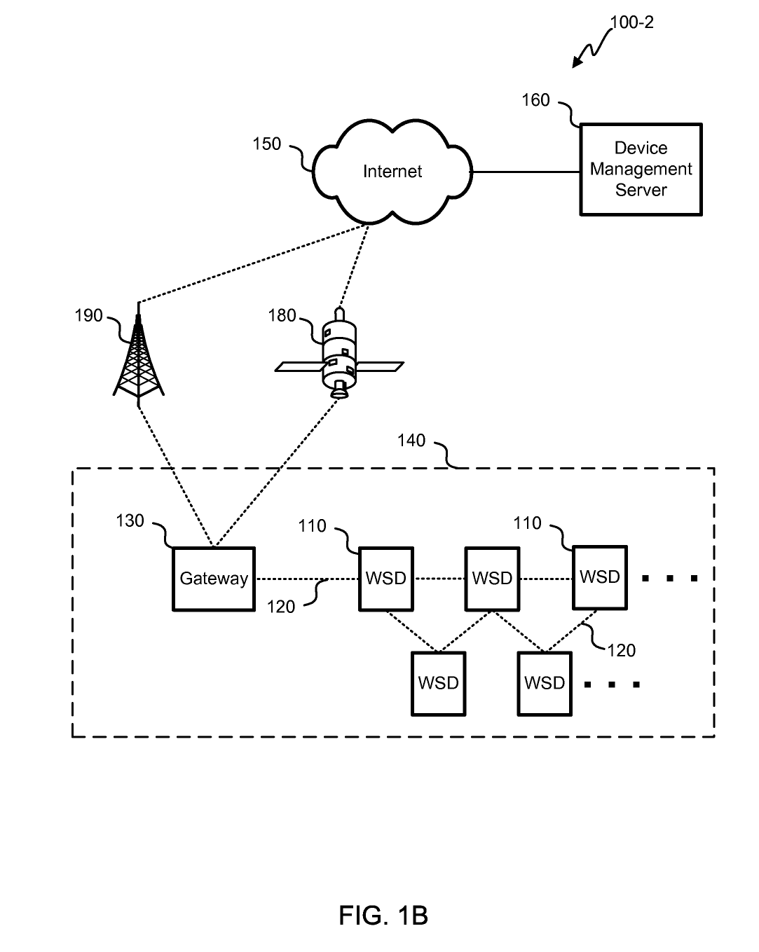

FIG. 1A is a block diagram of an embodiment of a logistical management system 100-1. In this embodiment, a plurality of WSDs 110 are networked together to generate and communicate sensor data. A WSD 110 gathering sensor information can communicate the sensor information toward a gateway 130 using a wireless connection 120. If there are one or more WSDs 110 communicatively linked between the WSD 110 originating the sensor information and the gateway 130, the one or more WSDs 110 will relay the sensor information until it reaches the gateway 130. The logistical management system 100-1 depicted in FIG. 1A is shown as an example and is not limiting. The sensor network 140 can be configured in a variety of ways. For instance, the gateway 130 can connect with multiple WSDs 110, and WSDs 110 can have more or fewer wireless connections 120 than indicated in FIG. 1A. Moreover, multiple gateways 130 and/or sensor networks 140 may be included in a logistical management system 100.

The gateway 130 provides connectivity between sensor network 140—comprising the gateway 130 and WSDs 110—and a device management server (DMS) 160. Communication between the gateway 130 and the DMS 160 can be relayed through the Internet 150 or any other Wide Area Network (WAN). Additionally or alternatively, other networks, such as Local Area Networks (LANs), can be used. Other configurations can include a gateway 130 communicating directly with the DMS 160 without a separate network.

The DMS 160 provides an interface between the sensor network 140 that can be used, by a human user or another system, by utilizing, for example, a graphical user interface (GUI) and/or an application programmable interface (API). The DMS 160 can collect and store information from the WSDs 110. The data communicated between the DMS 160 and the gateway 130 can be securely communicated in encrypted packets, and the DMS 160 can provide secure management of the collected data.

One or more of a variety of physical layers may be used to provide the wireless connections 120 of the sensor network 140. According to one embodiment, the WSDs 110 and gateway 130 communicate using a protocol stack based on IEEE 802.15.4 standard at 2.4 GHz using all 16 channels available in that standard. This physical layer enables the sensor network 140 to operate using very low power and/or predictable power consumption—which can be an important consideration for embodiments in which the WSDs 110 and/or gateway 130 operate on battery power. Nonetheless, other wireless technologies may be used, including IEEE 802.15.4 at 900 MHz; IEEE 802.11; Bluetooth®; IEEE 802.16; Ultra Wideband (UWB); 433 MHz Industrial, Scientific, and Medical (ISM) Band; cellular; optical; and more, using use multiple RF channels (e.g., narrow-band frequency hopping) or a single RF channel. The gateway 130 can communicate with the Internet 150 through a wired connection and/or a wireless connection, as shown in FIG. 1B.

FIG. 1B is a block diagram of an alternative embodiment of a logistical management system 100-2. In this embodiment, the gateway 130 can communicate with the Internet 150 wirelessly, through wireless communications with a satellite 180 and/or a cellular tower 190. The user of such a wireless interface between the gateway 130 and the Internet 150 can be a factor of available internet connectivity and desired mobility of the sensor network 140, among other considerations.

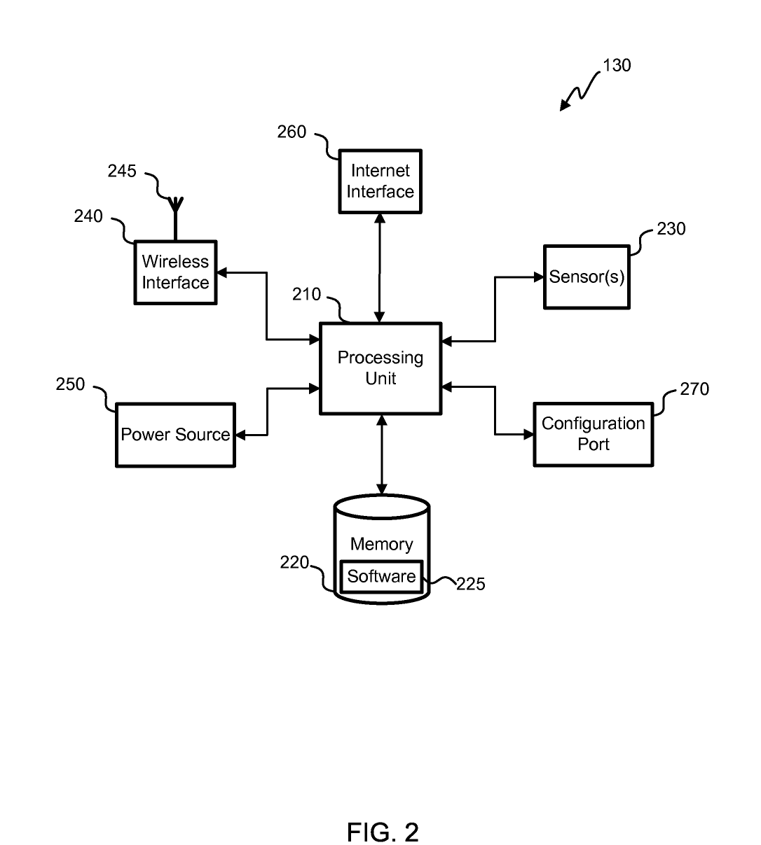

FIG. 2 is a block diagram of an embodiment of a gateway device 130. This block diagram, as with other figures shown herein, is provided as an example only and is not limiting. The gateway device 130 can be configured in alternate ways by including, for example, a global positioning system (GPS) unit and/or other components not shown in FIG. 2.

A processing unit 210 lies in the heart of the gateway device 130. The processing unit 210 can be comprised of one or more processors, microprocessors, and/or specialized integrated circuits. The processing unit 210 can gather information from the other components of the gateway device 130 and process the information in accordance with software 225 disposed in memory 220. Depending on desired functionality of the gateway device 130 and the capabilities of the processing unit 210, the software 225 can include an operating system with one or more executable programs. Alternatively, the software can include lower-level instructions, such as firmware and/or microcode, for the processing unit 210 to execute.

The power source 250 supplies power to the components of the gateway device 130 and may provide additional information (e.g., battery charge, voltage levels, etc.) to the processing unit 210. For a mobile gateway device 130, the power source 250 can comprise one or more batteries. For a fixed gateway device 130, the power source can include a power converter, transformer, and/or voltage regulator.

The wireless interface 240 provides communication with WSDs 110. As indicated above, this communication can be effectuated using any of a variety of technologies, including radio frequency (RF) and/or optical communication technologies. Where RF technologies are used, the wireless interface can include an antenna 245.

The gateway device 130 can also include a configuration port 270, which may allow a device, such as a computer, to be connected to the gateway device 130 for the purposes of configuring the gateway device 130. The configuration port 270 can comprise universal serial bus (USB) connector, serial port, optical, or other connector to input information from an external device. Depending on the functionality of the gateway device 130 and/or WSDs 110, the configuration port 270 may be used to configure device information and reporting, sensor parameters, software, security, network parameters, power consumption, GPS parameters, file management, and more.

The Internet interface 260 can be any of a variety of interfaces, depending on desired functionality. As indicated in FIG. 1A, the gateway device 130 can have a wired connection with the Internet, in which case the Internet interface 260 can include an Ethernet or other wired interface. Additionally or alternatively, the gateway device 130 can have a wireless connection with the Internet, as indicated in FIG. 1B. In this case, the Internet interface can comprise one or more wireless radios, such as a dual-mode WAN radio enabling cellular and satellite communication.

The gateway device 130 further can include sensor(s) 230, enabling the gateway device to collect sensor information similar to the WSDs. This sensor information can include information relating to temperature, humidity, motion, light, battery charge, shock, and application-specific information (e.g. the state of a door—open or closed—on a cargo container). Depending on desired functionality, the processing unit 210 may collect, process, and/or record the sensor information, or the processing unit 210 simply may send unprocessed sensor information to the DMS 160 using the Internet interface 260.

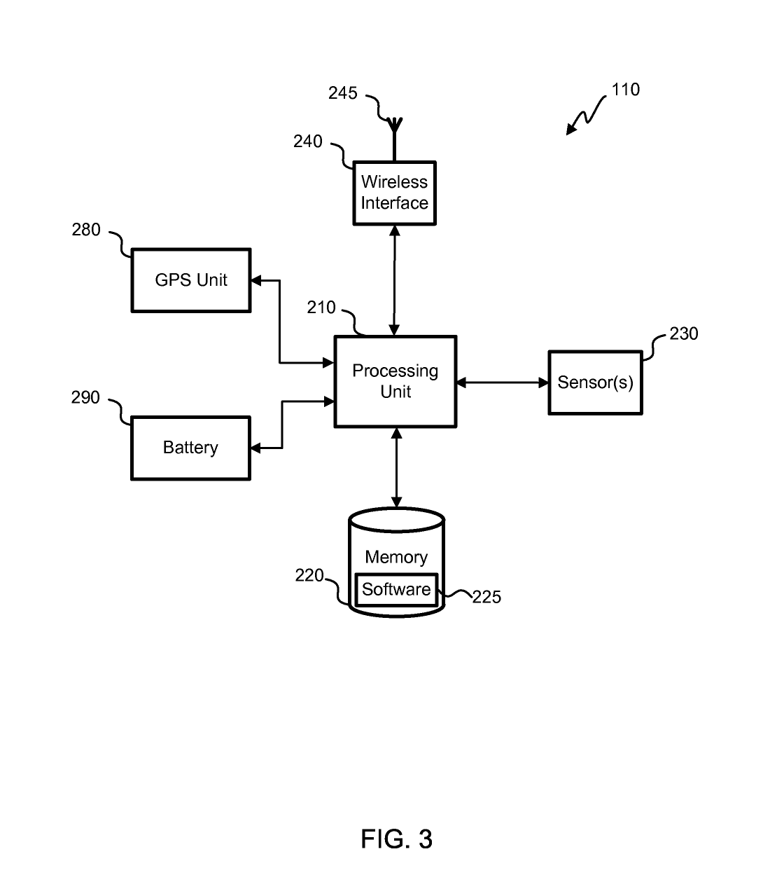

FIG. 3 is a block diagram of an embodiment of a WSD 110. This embodiment includes many components—such as the sensor(s) 230, processing unit 210, memory 220, and wireless interface 240—that are similar to the gateway device 130. Here, however, the components may be simpler than corresponding components of the gateway device 130, due to power and functionality considerations. For example, the processing unit 210 can comprise a microprocessor and the memory 220 and software 225 can comprise programmed logic of the microprocessor. It can also be noted that the WSD 110 and/or the gateway device can include an interface (not shown) to provide a user with information. Such an interface can comprise a liquid-crystal display (LCD), one or more light emitting diodes (LEDs), etc.

WSD 110 further includes a battery 290. Because the wireless network can provide lower-power consumption, a battery having a long shelf life—such as an alkaline-, silver-oxide-, or lithium-based battery—can provide for operability of the WSD 110 without the need to change batteries for several years. According to one embodiment, a WSD 110 uses up to 4 A-size 3.6 volt (V) batteries, each battery rated at approximately 3600 milliamp hours (mAh). Some embodiments of the WSD 110 have an operating power of under 2 milliwatts (mW); other embodiments of the WSD operate under 1 mW. Therefore, depending on the battery's shelf life and capacity, as well as the configuration of the WSD 110, the WSD 110 can operate for 10 years or more without the need to change the battery.

The WSD 110 can also include a GPS unit 280 to provide location information. Location information can be particularly useful where a sensor network 140 is spread over a large physical area. Moreover, the GPS unit 280 further can be used to sense motion of the WSD 110 by determining, by the GPS unit 280 and/or the processing unit 210, a change in location over time. In the absence of a GPS unit 280, the WSD 110 can receive location information from another source, either external or internal. For example, the WSD 110 can receive location information from a transport vessel, such as a cargo ship or truck, which is transporting an asset.

Using embodiments of the present invention, a data structure can be created and stored in the memory 220 of the WSD 110. This data structure can be configured to represent areas within a geographic region that belonged to one or more geographic zones. The WSG 110 may then use the location information received from the GPS unit 280 or from next kernel source to traverse the data structure and determine whether the WSG 110 is within one or more of the geographic zones. Based on a determination that the WSG 110 is within one or more of the geographic zones, the WSG 110 may take action according to information stored in the data structure. Additionally or alternatively, the WSG 110 can use the determination that it is in one or more the geographic zones to selectively receive and/or process incoming messages based on geography.

As used herein, a “geographic region” may refer to a geographic area of interest. A geographic region may be a country, state, city, county, continent, or any other jurisdiction defined by political or national boundaries. Additionally, geographic region may comprise a specially defined geographic region in which one or more asset tracking devices might be located. For example, a geographic region could be a war zone defined by military authority. In another example, a geographic region could be an area proximate to a trade route. In one embodiment, the geographic region may be considered the entire surface of the earth, particularly for asset tracking device applications that travel worldwide.

According to one embodiment, the geographic region may be defined using the user interface on a computer system. A map may be displayed to a user, and the user may use an input device to select a geographic region. For example, a user may zoom the display into a rectangular map area and define this area to be the geographic region. In another example, a user may use a larger display. Alternatively, a set of coordinates defining the boundaries of the geographic region may be provided. These coordinates may be provided by user or by another computer system. In one embodiment, previous routes recorded by asset tracking devices may be used to define a geographic region corresponding to possible locations of the asset tracking devices in the future. In other words, if records show that a group of asset tracking devices moved within a 100 mi.² area, then this area could be used as the geographic region for future applications.

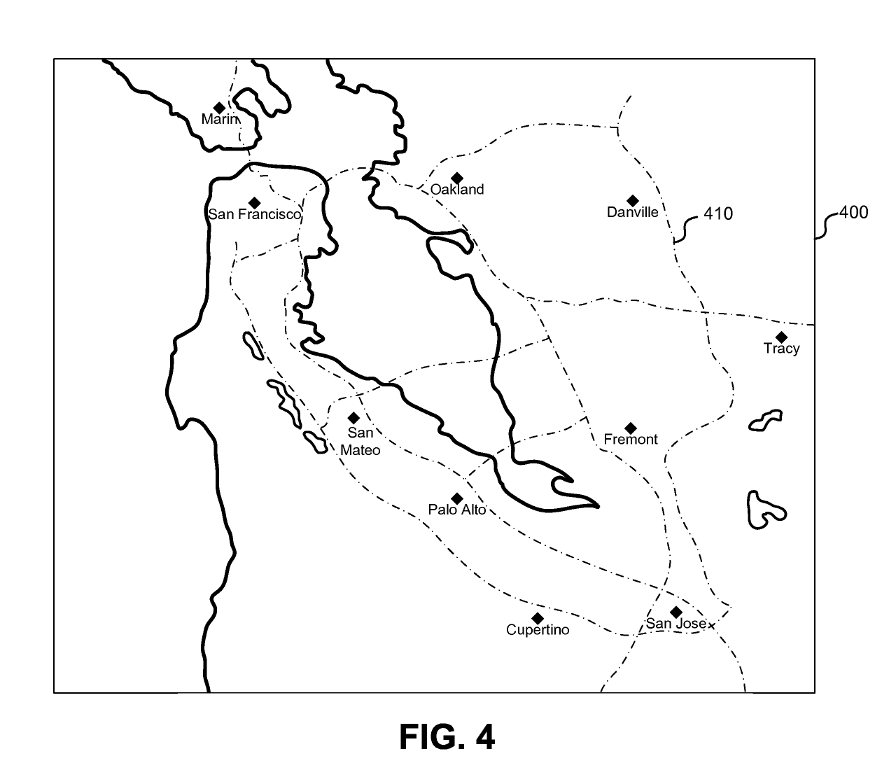

FIG. 4 illustrates a geographic region 400, according to one embodiment. This geographic region corresponds to the San Francisco Bay Area of Northern California in the United States. A number of different routes 410 are illustrated within the geographic region 400. These routes 410 may correspond to previously recorded routes used by a group of one or more asset tracking devices. As described above, the geographic region 400 may be defined based on these routes 410 to include a rectangular area that at least includes the routes 410. Alternatively, the geographic region 400 may be manually or automatically selected based on other criteria.

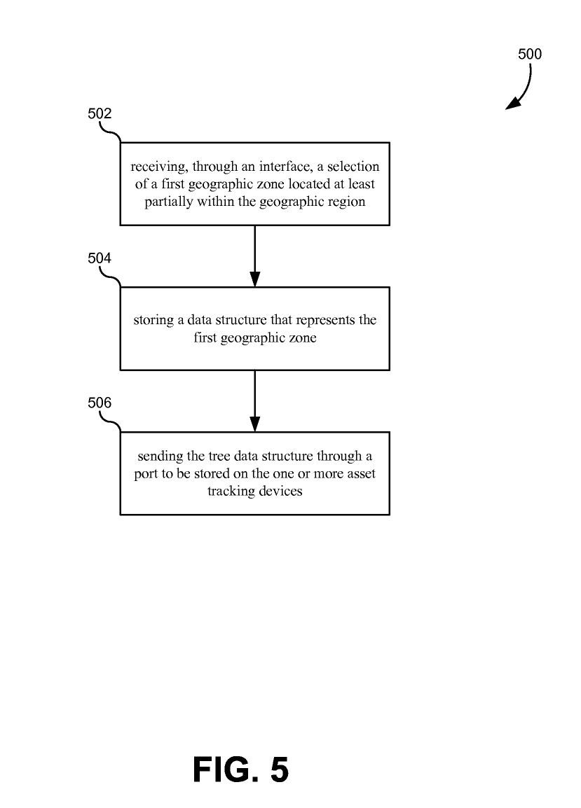

FIG. 5 illustrates a flowchart 500 for a method of creating geographic zones within a geographic region for influencing the operations of one or more asset tracking devices that can be remotely located within the geographic region, according to one embodiment. The method may include receiving, through an interface, a selection of a first geographic zone located at least partially within the geographic region (502). As used herein, a “geographic zone”, or simply “zone”, is a zone selected from within a geographic region. As described above, a geographic zone, or “geo-zone” may be any size or shape. In contrast to previous solutions, zones need not be continuous. Furthermore, a single geographic region may contain an unlimited number of geographic zones. Geographic zones may overlap. Multiple geographic zones within a geographic region may be referred to as a “first geographic zone”, a “second geographic zone”, etc. One geographic zone may exist entirely within a second geographic zone. Two geographic zones may also represent the same area and be nearly identical.

Like a geographic region, each geographic zone may be defined by a user using a map-based computer interface. In one embodiment, a mouse or pen input device may be used to draw the boundary of a geographic region on a screen, and a computer system may translate the graphical representation of the geographic zone into a data structure, using a method that will be described further below. Alternatively, geographic zones may be defined automatically based on political or geographic boundaries, prior asset movement histories, or other similar criteria.

Geographic zones and geographic regions may both be defined using a computer system that is more powerful than the processing capabilities of the individual asset tracking devices. In one embodiment, a computer system at the DMS 160 in FIG. 1 may be used to define geographic regions and zones and store them within a data structure. Alternatively, any computer workstation or mobile computing device may be used to select and define geographic zones and regions.

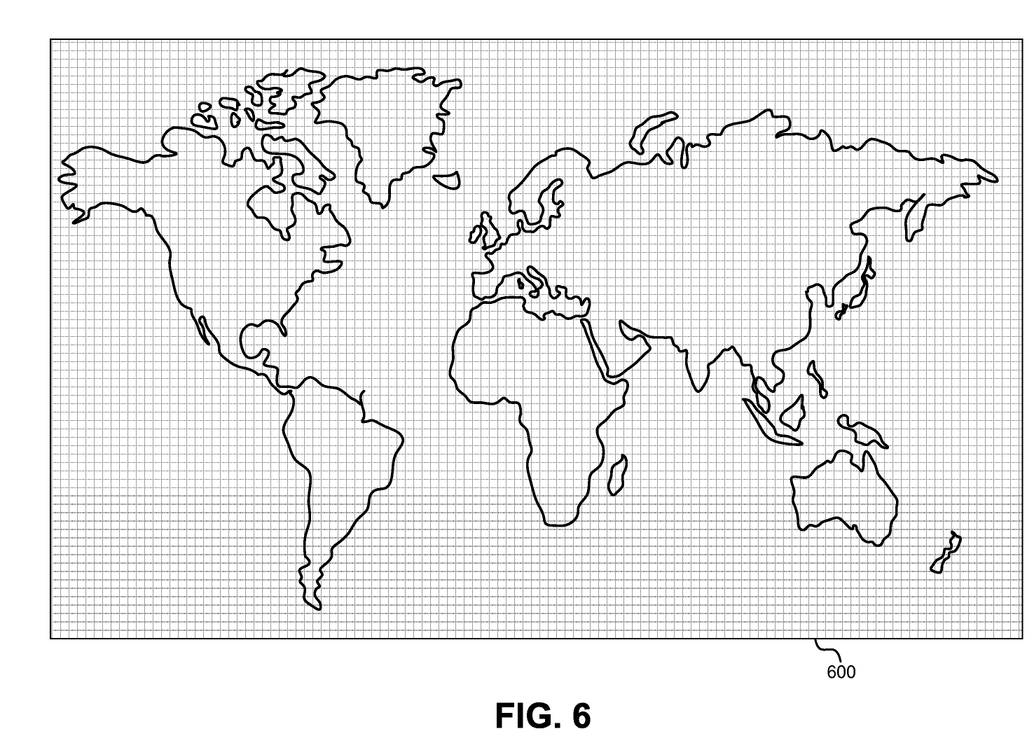

The method may further include storing a data structure that represents the first geographic zone (504). According to one embodiment, the data structure may be a tree data structure. According to another embodiment, the tree data structure may be a binary tree data structure. The method may also include sending the tree data structure through a port to be stored on the one or more asset tracking devices (506). In order to understand how geographic zones may be stored within the data structure, it may be useful to consider how a geographic region may be quantized into a number of sub-areas. For example, FIG. 6 illustrates a geographic region 600 that is subdivided into a number of rectangular subareas. Here, the geographic region 600 corresponds to a rectangle representation of the surface area of the earth. Each rectangular subarea is of equal size and dimension; however, other embodiments may use subareas that are not rectangular and not necessarily equal in size. For example, each sub area may be a latitude and longitude defined rectangle corresponding to the curvature of the earth.

According to one embodiment, the number of horizontal and vertical divisions in the region may be equal. Furthermore, the number of divisions in the horizontal and vertical directions may be an integer number defined by 2^{N} were N is an integer value. When 2^{N} divisions are used in each direction, then it is possible to subdivide the geographic region according to a corresponding base-2 tree structure, as will be described in further detail below. It will be understood that other integer bases may be used to determine the number of horizontal and vertical divisions, and that this may correspond to tree structures wherein the number of children at each level are determined by the integer base of the divisions. In one exemplary embodiment, the world map corresponding to geographic region 600 can be pixelized into a grid of 2^{N} by 2^{N} elemental rectangle units. For example, if 3 octet (24 bit) unsigned numbers are used, the pixels (or rectangular areas) can use resolution down to approximately 2 m² anywhere on the earth's surface. Any area of the world can be then defined using these elemental rectangular units, or pixels.

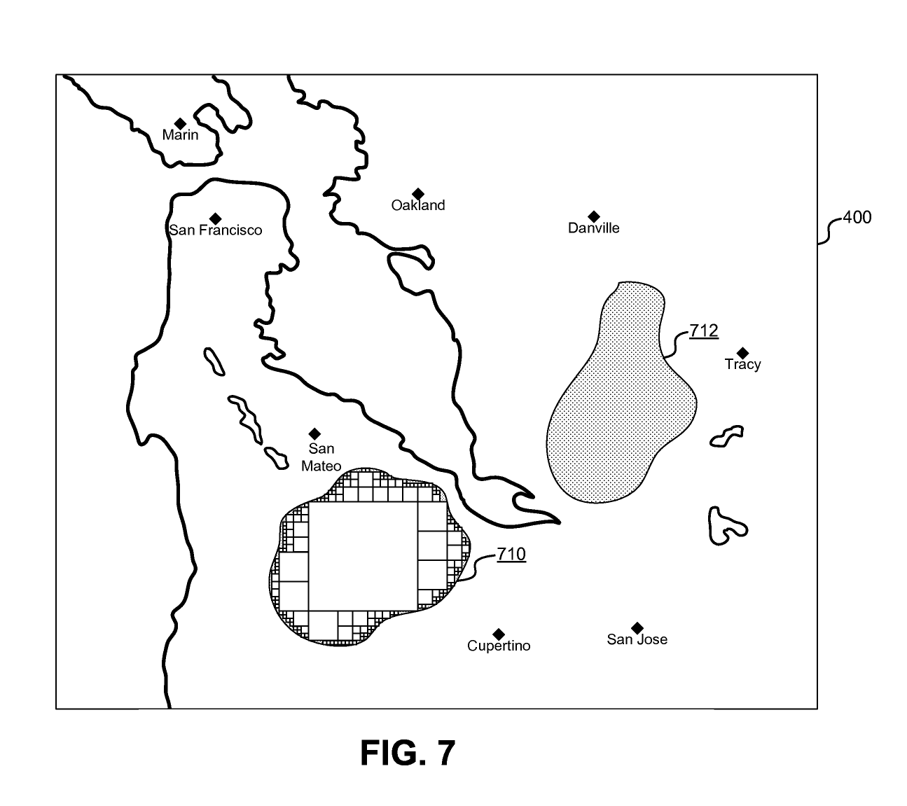

FIG. 7 illustrates defining geographic zones using subdivided rectangular divisions, according to one embodiment. In this embodiment, the geographic region corresponds to geographic region 400 from FIG. 4. To geographic zones are defined within the geographic region 400, namely zone 710 and zone 712. Note that the zones are of arbitrary shape and include both convex and concave curves.

Zone 710 illustrates how a zone may be defined using subdivided rectangles. In this embodiment, zone 710 is represented using the largest rectangles possible. These large rectangles may correspond to the fewest number of necessary divisions to fit a rectangle within zone 710. The remaining areas of zone 710 may then be fielding using smaller rectangles resulting from a larger number of horizontal and vertical divisions of the geographic region 400. As shown, particularly around the borders of zone 710, the rectangles may become a small as necessary to achieve the desired precision.

To further illustrate how zones may be defined and represented in a data structure, an example will be presented for three overlapping zones. This example is greatly simplified, using very coarse resolution and basic shapes for the geographic zones. It will be understood that the description that follows is merely exemplary and not meant to be limiting. Real-world applications of the embodiments described herein may be much more complex.

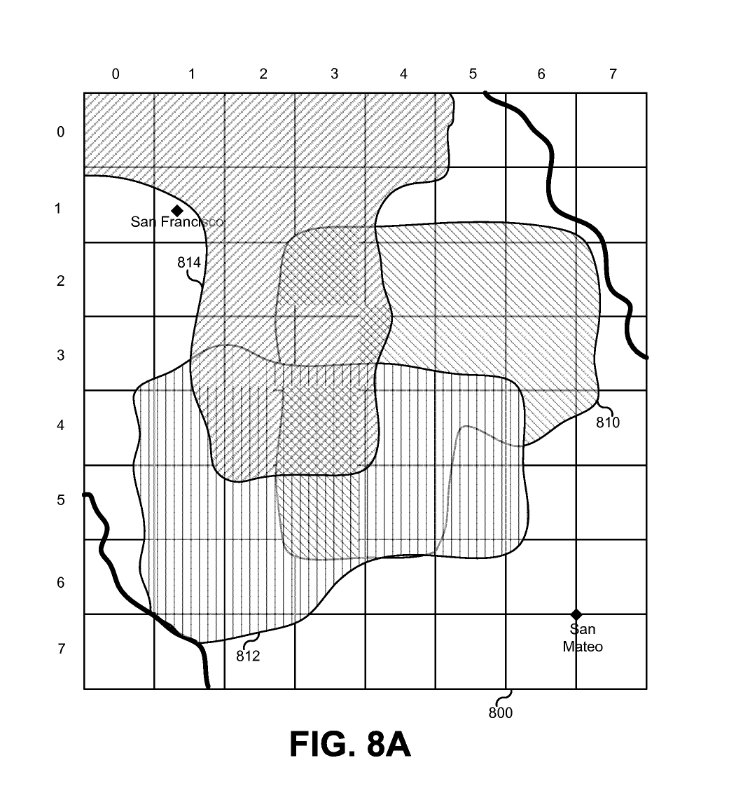

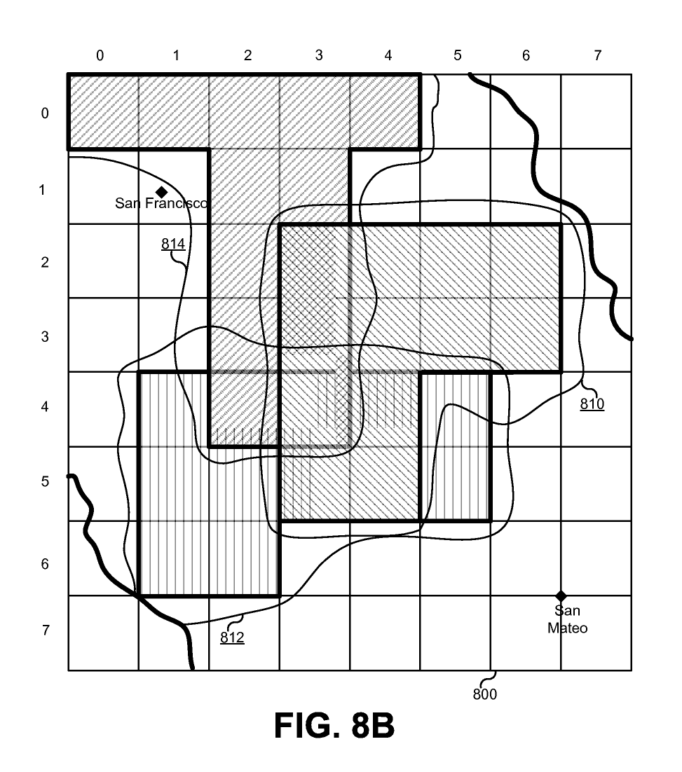

FIG. 8A illustrates a map with three geographic zones, according to one embodiment. The map may correspond roughly to the San Francisco Bay Area illustrated in FIG. 7. In this example, the map may be considered a geographic area of interest for this application, and may thus be termed the geographic region 800. The geographic region 800 is subdivided at the lowest level into a grid of rectangular elements. In this example, there are eight vertical and horizontal divisions in the grid, or 2³ divisions. Although the number of horizontal and vertical divisions are equal, this need not be the case in other embodiments.

Within the geographic region 800, three geographic zones have been selected or defined, namely geographic zone 810, geographic zone 812, and geographic zone 814. The three geographic zones 810, 812, 814 each overlap one or more of the other zones. At the center of geographic region 800, all three geographic zones 810, 812, 814 overlap the same section. Furthermore, geographic zone 814 has boundaries that appear to extend outside of the geographic region 800. Geographic zone 814 may have its top and left boundaries defined by the boundaries of the geographic region 800, even though the actual boundaries of geographic zone 814 may extend further.

The example in FIG. 8A may correspond to a user interface on a computer system. The three geographic zones 810, 812, 814 may be selected by a user on the user interface or a software process. In one embodiment, the example in FIG. 8A may be displayed on a touch screen as a part of a Google map interface, and the three geographic zones 810, 812, 814 may be drawn by user with a mouse, finger gesture, an input, and/or the like. Again, although the three geographic zones 810, 812, 814 are contiguous in this example, more complex zones may have holes, voids, and multiple noncontiguous areas.

The three geographic zones 810, 812, 814 may be drawn with irregular borders that do not coincide with the rectangular grid. In FIG. 8A, each geographic zone has borders that extend through the rectangular elements, rather than running with the grid lines. In one embodiment, the boundaries of each geographic zone may be adjusted such that they coincide with the rectangular grid. FIG. 8B illustrates geographic zones that are adjusted to coincide with the rectangular grid, according to one embodiment. Here, the boundaries of each geographic zone are adjusted such that the boundaries coincide with the outermost border of the rectangular elements that are completely encompassed by each geographic zone. In other words, the borders of each geographic zone are shrunk until they conform to grid lines that are encompassed by the zone. In another embodiment, the opposite operations are performed, and the geographic zone boundaries are expanded until they meet grid lines that are outside of the zone. In yet another embodiment, geographic zone boundaries may be either expanded or contracted depending on the area of a rectangular element that they encompass.

Generally, the methods presented herein do not need to adjust the boundaries of the geographic zones in order to operate. Although the zones will be represented within a data structure according to the boundaries of the rectangular elements of the grid, these methods may operate without making actual boundary adjustments as will be shown below. Therefore in the remaining figures, both the original zone boundaries and the grid representation will be shown for clarity.

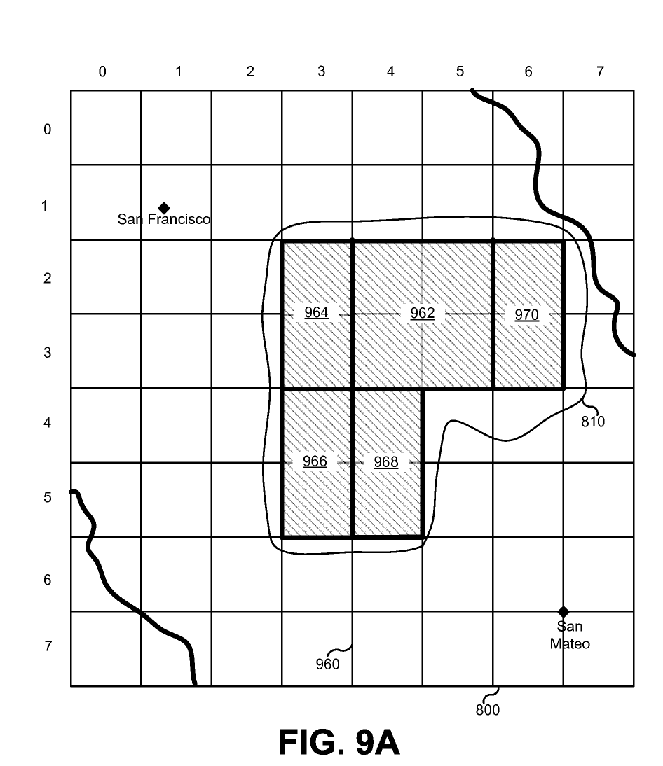

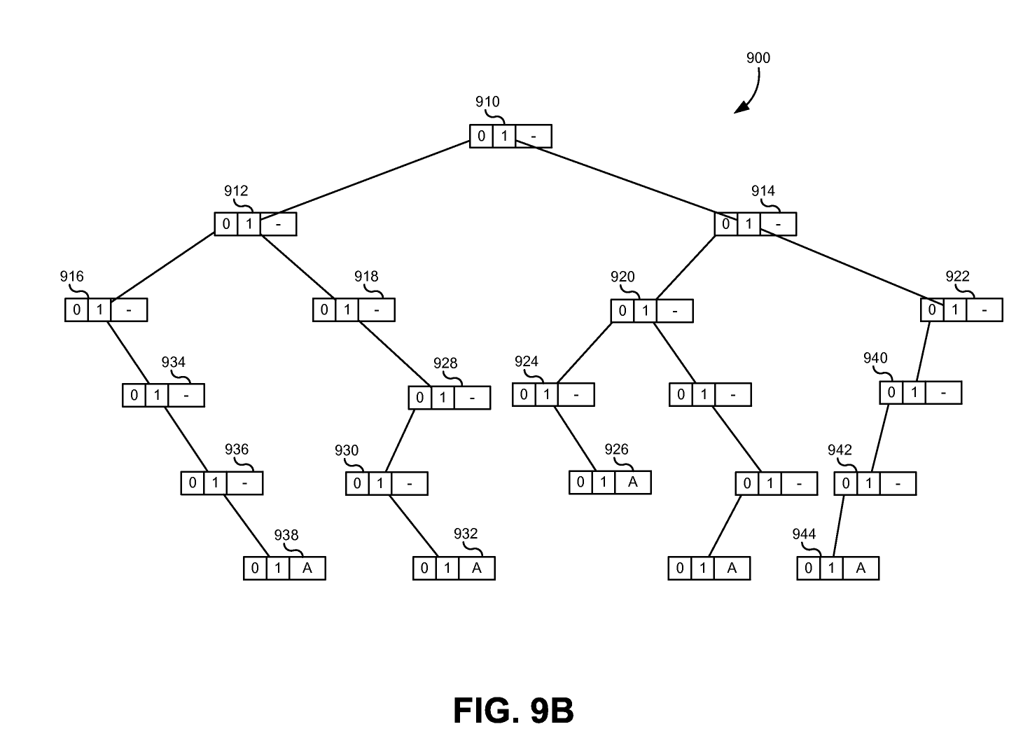

To illustrate how a geographic zone may be represented within a data structure, FIG. 9A illustrates geographic zone 810. FIG. 9B illustrates one embodiment of a corresponding data structure 900 representing geographic zone 810. In this embodiment, the data structure 900 comprises a tree data structure. Specifically, the data structure 900 may be a binary tree data structure. The data structure 900 may be comprised of a plurality of nodes. Each of the plurality of nodes may be organized into a plurality of parent-child relationships. In this embodiment, each node may contain a pointer or other type of reference to two child nodes. Specifically, each node may contain a pointer to a left child node, represented by a “0”, and a pointer to a right child node, represented by a “1”. In some embodiments, each node may also contain additional pointers corresponding to other types of relationships, such as a pointer to a parent node. Although this embodiment specifically uses a binary tree, other types of data structures are also implemented by various embodiments. For example, a quad tree may be used (wherein each node has four children), or an array may be used to represent parent-child relationships.

Each node in the data structure may represent a geographic area. The geographic areas represented by each node may be distinct. Alternatively, some of the geographic areas may overlap. The data structure 900 may include a root node 910 that represents the geographic region 800. Furthermore, each child node in the plurality of parent-child relationships may represent a sub area of a geographic area represented by the respective parent node. For example, root node 910 has two child nodes, namely node 912 and node 914. Because root node 910 represents the geographic region 800, node 912 and notice 914 may each represent one half of the geographic region 800. According to one embodiment, the left child node of the root node 910 represented by the “0” pointer (node 912) may represent the left half of the geographic region 800 according to a division created by vertical line 960. Similarly, the right child node of the root node 910, represented by the “1” pointer (node 914), may represent the right half of the geographic region 800.

According to one embodiment, each node in the plurality of nodes may represent a geographic area that at least partially overlaps with the geographic zone 810. In other words, the data structure 900 only needs to include nodes that represent geographic areas that intersect with one or more of the geographic zones. This feature may become particularly important as the resolution of the geographic zones increases, i.e. as the number of divisions in the grid become more numerous. Grids with a relatively large number of divisions may require a lot of memory, particularly considering the limited memory resources that may be available on most asset tracking devices. Therefore, eliminating nodes that represent areas that do not intersect with any of the geographic zones from the data structure 900 may in some cases greatly reduce the size of the data structure 900.

Each possible path in traversing the data structure 900 may end with a rectangular block of one or more rectangular elements that is entirely contained within one or more the geographic zones. In the case of the binary tree in FIG. 9B, each level may divide a geographic area of a parent in the previous level in either the X or Y (horizontal or vertical) direction. Node 912 and node 914 may be considered the second level in the binary tree and may represent one half of the geographic region 800 represented by the root node 910 according to a vertical division along the x-axis. Nodes 916, 918, 920, and 922 may be considered the third level of the binary tree, and may represent one half of the region represented by their respective parents divided according to horizontal division through the Y axis. In other words, the levels of the binary tree in this embodiment alternate between horizontal and vertical divisions of the geographic areas represented by the parents in the previous level.

In one embodiment, left child nodes, or “0” nodes, may represent the left half of a parent's geographic area for X coordinate levels, and right child nodes, or “1” nodes, may represent the right half of a parent's geographic area. Similarly, left child nodes, or “0” nodes, may represent the top half of a parent's geographic area for Y coordinate levels, and right child nodes, or “1” nodes, may represent the bottom half of a parent's geographic area. For example, in order to represent rectangular block 962 in FIG. 9A, the following nodes may be placed in the tree. Root node 910 (representing the geographic region 800), left child “1” node, or node 914 (representing the of the geographic region 800 with X coordinates 4-7), right child “0” node, or node 920 (representing the top half of the geographic area represented by node 914, which is the top right quadrant of geographic region 800), right child “0” node, or node 924 (representing the left half of the top right quadrant represented by node 920), and finally right child “1” node, or node 926 (representing the bottom half of the geographic area represented by node 924).

In this embodiment, node 926 representing rectangular block 962 need not have any child nodes associated with it. Child nodes would subdivide the geographic area of rectangular block 962 into smaller elements. However, there is little reason to do this since the entire rectangular block 962 resides within geographic zone 810. By ending this branch of the data structure 900 as soon as an entire geographic area represented by a node is within the geographic zone 810, the overall complexity and size of the data structure 900 can be effectively minimized.

In some embodiments, each node in the plurality of nodes representing a geographic area that is entirely within a geographic zone may include an identifier associated with that particular geographic zone. For example, in addition to including pointers to left and right children (“0” and “1” children), each node can include an additional indicator of the particular geographic zone. In FIG. 9B, node 926 includes an indicator marked with an “A” to signify that a traversal of the data structure 900 that ends on, or passes through, node 926 will fall within geographic zone 810. In some embodiments, the indicator may be a pointer to another section of code that should be executed when an asset tracking device determines that it is within zone 810. The section of code may be stored as a part of the data structure 900 itself. In other embodiments, the section of code may be stored separately and may be defined based on the type and/or location of the asset tracking device on which the data structure 900 is stored. The indicator “A” can be a pointer to other code or can be a placeholder that is replaced with a pointer when the data structure 900 is stored on an asset tracking device.

Continuing on with the example of FIG. 9A and FIG. 9B, geographic zone 810 can be represented using four additional rectangular blocks, namely rectangular blocks 964, 966, 968, and 970. Each of these blocks can be represented by adding additional nodes within the data structure 900. For example, rectangular block 966 may be represented by the pathway of nodes including nodes 910, 912, 918, 928, 930, and 932. Similarly, rectangular block 964 may be represented by the pathway of nodes including nodes 910, 912, 916, 934, 936, and 938. Rectangular blocks 968 and 970 may similarly be represented by a pathway of nodes shown in the data structure by alternatively dividing the geographic region 800 in half in the X and Y coordinate directions. The data structure 900 in FIG. 9B may fully represent geographic zone 810. Note that because this embodiment begins with dividing in the X direction, square blocks are first divided in half to form vertical rectangles. This may be advantageous where a geographic zone may be most efficiently represented by squares and vertical rectangles. According to another embodiment, the data structure 900 may begin by dividing in the Y direction, which would result in squares that are divided into horizontal rectangles. This may be advantageous where geographic zone may be most efficiently represented by squares and horizontal rectangles. In yet another embodiment, these two options may be mixed according to algorithms that determine the most efficient representation for each geographic zone.

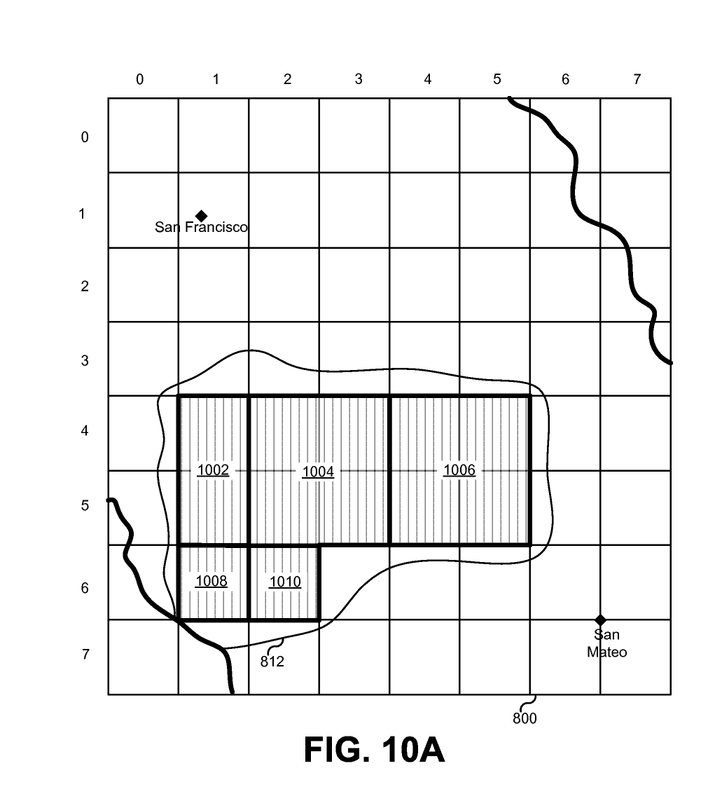

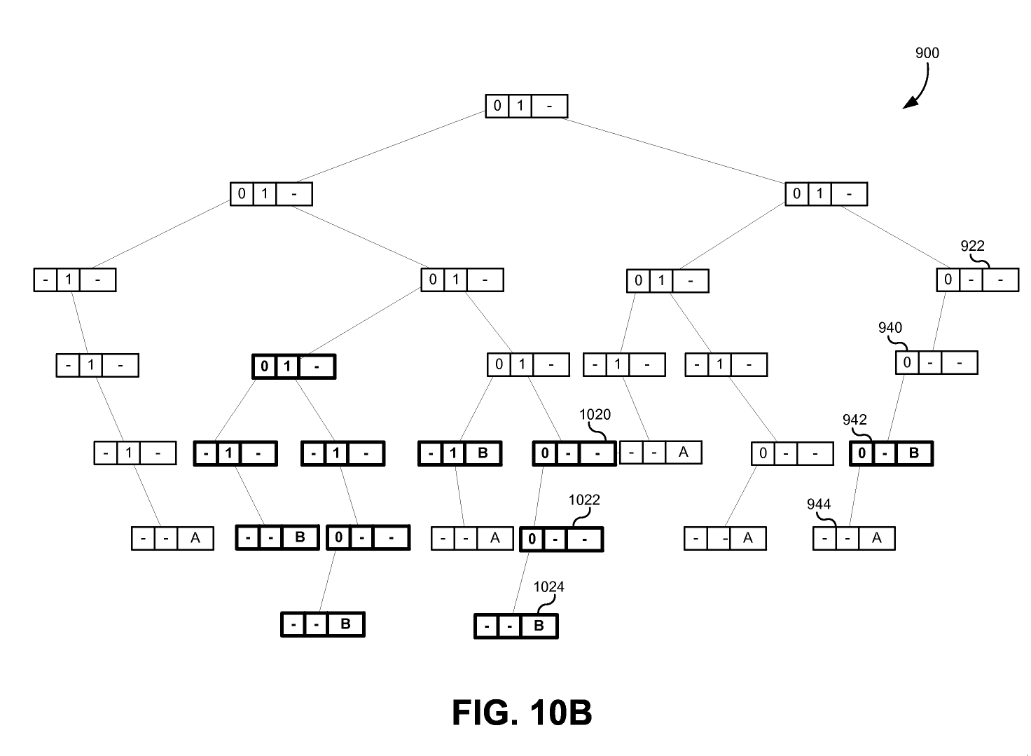

The data structure 900 representing geographic zone 810 may be augmented to represent a second geographic zone, such as geographic zone 812 from FIG. 8A. FIG. 10A illustrates geographic zone 812 broken up into five rectangular blocks, namely block 1002, block 1004, block 1006, block 1008, and block 1010. Again, these blocks represent the largest squares and vertical rectangles that may be represented using the alternating X and Y dividing scheme previously described. FIG. 10B illustrates how the data structure 900 may be augmented to represent both geographic zone 810 and geographic zone 812.

In some cases, blocks in the two geographic zones may overlap. Here, new nodes may not need to be added to data structure 900. Instead, indicators for geographic zone 812 may be added to existing nodes. For example, rectangular block 968 of geographic zone 810 in FIG. 9A is a sub area of rectangular block 1004 geographic zone 812 in FIG. 10A. Therefore, a node representing rectangular block 1004 is already present in the data structure 900, namely node 942. Instead of adding new node, an indication labeled “B” may be added to node 942. Although not shown in FIG. 10A, overlapping geographic zones may share common rectangular blocks. In this case, a single node may include indications to multiple geographic zones, such as “A” and “B”.

When adding a representation of zone 812 to data structure 900, the rectangular blocks that do not overlap with those of existing nodes may need to be added to the data structure 900. For example, rectangular block 1010 represents a geographic area does not overlap with any existing geographic areas represented by data structure 900. Therefore, additional nodes may be added to represent rectangular block 1010. Specifically, nodes 1020, 1022, and 1024 may be added, with an indication labeled “B” included in node 1024. Data structure 900, as augmented in FIG. 10B, can completely represent both geographic zone 810 and geographic zone 812. The nodes added or updated to represent geographic zone 812 are indicated with a bold border.

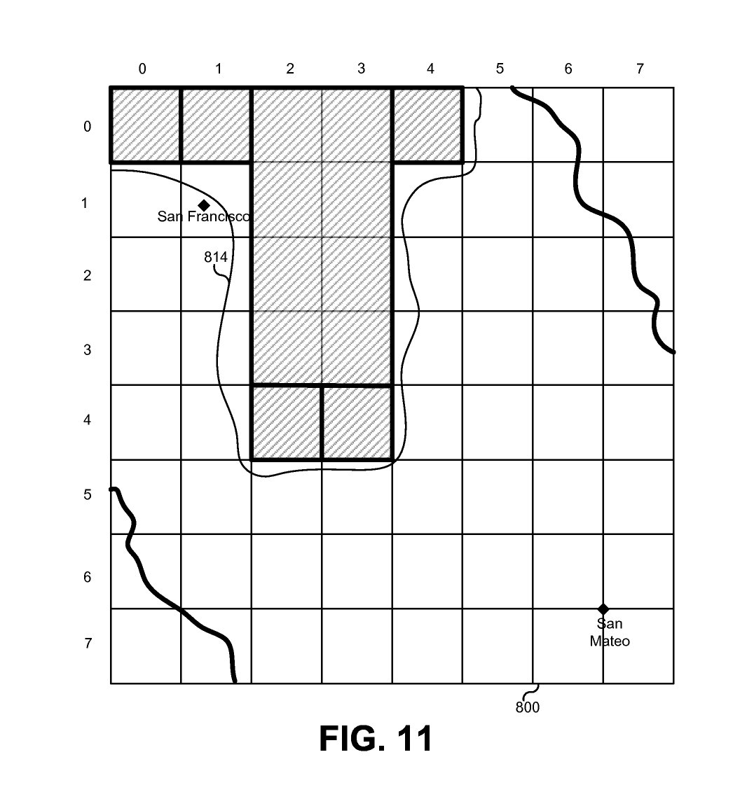

FIG. 11 illustrates how geographic zone 814 may be represented using squares and vertical rectangular blocks, according to the method described above. Although not shown for brevity, the data structure 900 in FIG. 10B can be edited and/or augmented to also represent geographic zone 814 in the same way that the data structure 900 was edited and/or augmented to represent geographic zone 812. It will be understood that any number of geographic zones may be represented using data structure 900. Furthermore, it will be understood that by only including nodes that represent geographic areas that partially overlap with geographic zones, the overall size of the data structure 900 may be greatly reduced. Likewise, by stopping the subdivision of geographic areas as soon as the geographic area is complete within a geographic zone, the overall size and complexity of the data structure 908 may also be greatly reduced. For example, using the 2³×2³ grid without the optimizations described in the previous examples, the data structure 900 would be six levels deep with 63 total nodes. However, by optimizing the data structure to represent only geographic zones, rather than every geographic area, the size of the data structure 900 is reduced by more than one half. This reduction may become much more pronounced as the size of the geographic region increases relative to the size of the geographic zones and as the resolution increases. Again, most real-world applications of these methods will include larger geographic areas relative to the geographic zones with much higher resolution. Thus, the size and complexity of the data structure in these applications may be even more greatly reduced than was shown in these simplified examples.

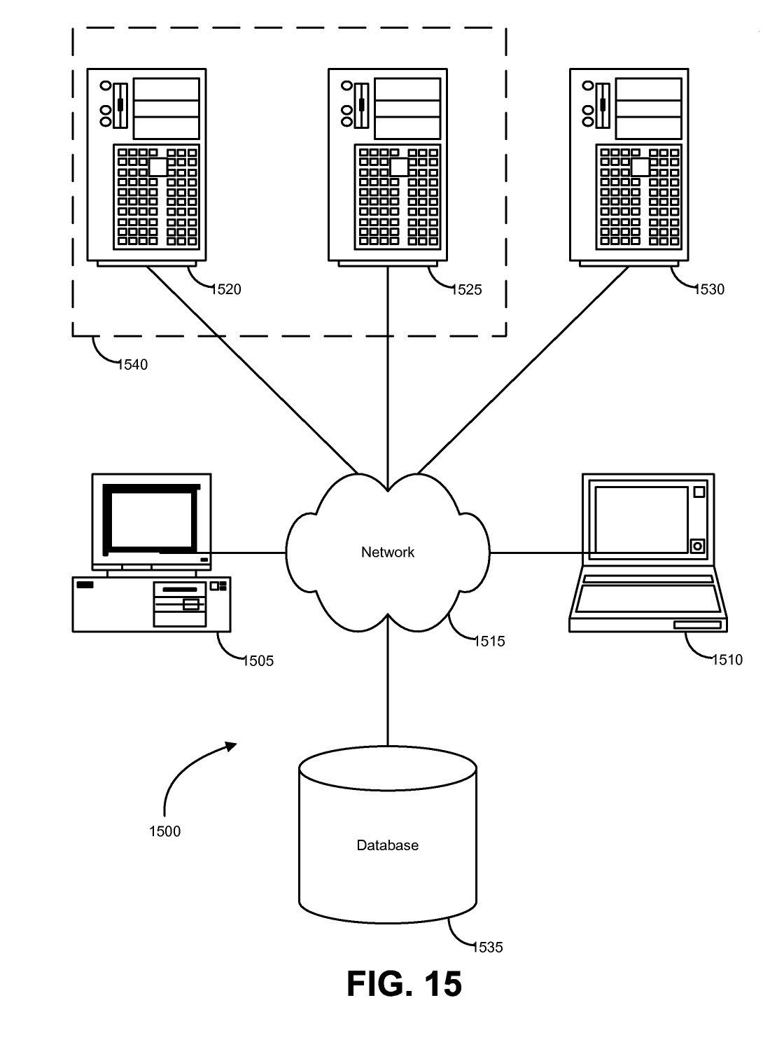

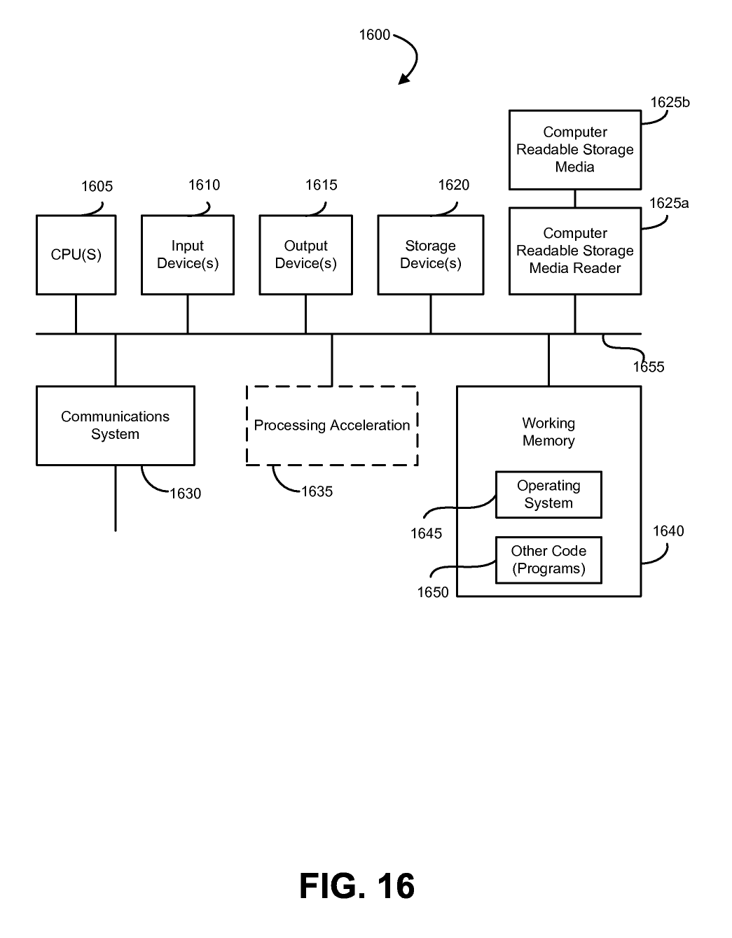

The previous examples of FIG. 6 through FIG. 11 illustrate how to construct a data structure representing one or more geographic zones that may be stored in a memory. Generally, this data structure representing geographic zones may be created or drawn using a computer system with sufficient resources, such as a central tracking monitoring station, or DMS 160. An exemplary computer system is described below in relation to FIG. 15 and FIG. 16. According to one embodiment, the data structure representing the geographic zones may then be stored on one or more asset tracking devices. An asset tracking device may then use the method described below to traverse the stored data structure and determine whether or not the asset tracking device is within one or more of the geographic zones.

According to one embodiment, the data structure may be stored in a memory of the asset tracking device, such as the memory 220 of the WSD 110 in FIG. 2. The data structure may be loaded onto the asset tracking device along with software used to influence the operation of the asset tracking device. Additionally or alternatively, the data structure may be transmitted wirelessly to the asset tracking device as it is operating or in the field of use. In one embodiment, the data structure may be transmitted wirelessly to an asset tracking device through a wireless sensor network is comprised of multiple asset tracking devices. For example, in FIG. 1A, the data structure may be defined at the DMS 160, transmitted through the Internet 150 to the gateway 130, and from there sent through the wireless network to each WSD 110.

When the data structure is transmitted to an asset tracking device, the entire data structure may be transmitted at once. When the data structure is updated, the updated version of the data structure can be transmitted to the asset tracking devices with only the changed portions of the data structure needing to be sent. This may minimize the number of data packets transmitted through a wireless sensor network and may minimize processing required for the update on an asset tracking device. Alternatively or additionally, the entire updated data structure may be transmitted to the asset tracking device, and the previously stored data structure may simply be overwritten in the memory of the asset tracking device. In yet another embodiment, the entire updated data structure may be transmitted to the asset tracking device, and the asset tracking device may determine which portions of the previously stored data structure need to be updated.

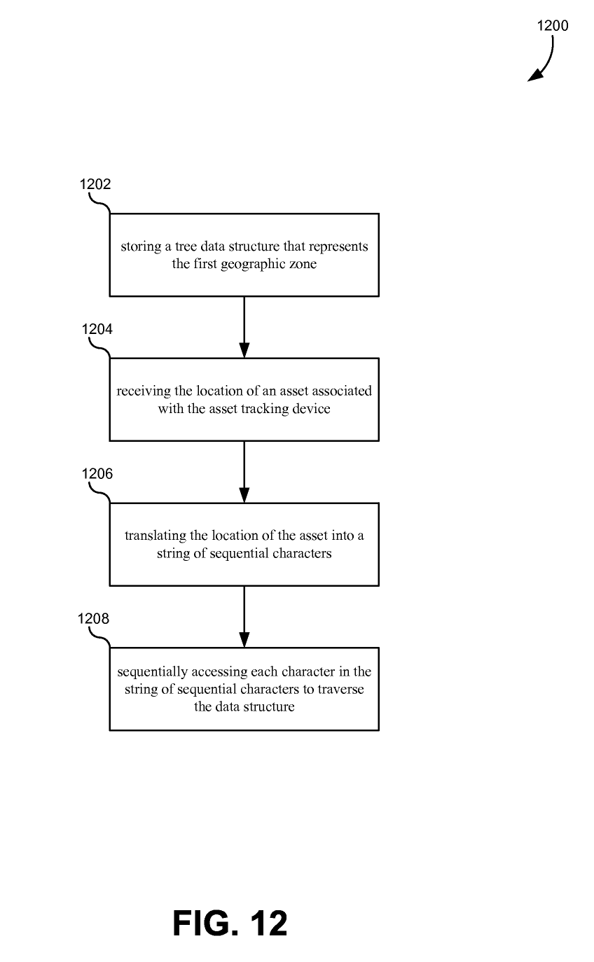

FIG. 12 illustrates a flowchart 1200 of a method of influencing the operations of an asset tracking device within a geographic region based on a location of the asset tracking device relative to a first geographic zone located at least partially within the geographic region. The method may include storing a tree data structure that represents the first geographic zone (1202). The tree data structure may be the same tree data structure that was created by the method of FIG. 5. Therefore, the tree data structure may be a binary tree data structure having a plurality of nodes organized into a plurality of parent-child relationships. Each of the plurality of nodes may represent geographic areas. The root node may represent the geographic region. Each child node may represent a subarea of a geographic area represented by the respective parent node. Each node may represent a geographic area that at least partially overlaps with the first geographic zone. Each node representing a geographic area that is entirely within the first geographic zone may include an identifier associated with the first geographic zone. The first geographic zone may be complex, have convex and concave curves, have holes or voids, and may be noncontiguous. The tree data structure may be stored in the memory of an asset tracking device. The trees data structure may be represented in the memory as an array with indexed locations corresponding to each level in the tree, or stored as a linked list, with each node having multiple links two child nodes.

The method may also include receiving the location of an asset associated with the asset tracking device (1204). The asset tracking device may be attached to the asset. In this embodiment, the location of the asset tracking device and location of the asset may be the same, and a GPS unit or other means for ascertaining the geographic location may be used to determine the location of the asset. In another embodiment, the asset tracking device may be stored in proximity to an asset. By using a GPS unit to ascertain the location of the asset tracking device, the location of the asset may be calculated therefrom. For example, an asset tracking device may be in radio contact with an asset and may use the strength of the radio transmission to determine a distance between the asset and the asset tracking device.

The method may further include translating the location of the asset into a string of sequential characters (1206). Translating the location of the asset may depend upon how the data structure is defined. In the embodiment described above, where the data structure was defined as a series of alternating X and Y divisions of the geographic region, the string of sequential characters may be translated such that each character corresponds to traversing one level in the data structure.

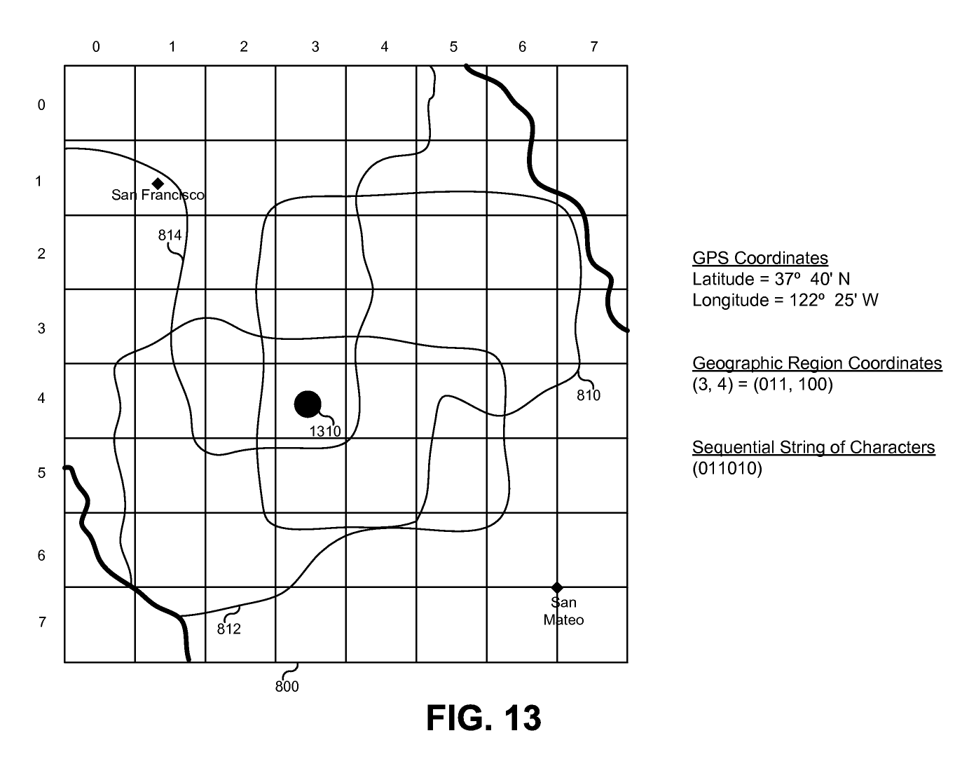

For example, the location of the asset may be represented by latitude and longitude coordinates. In this embodiment, the latitude and longitude may each be converted into a binary representation that corresponds to coordinates in a geographic region. FIG. 13 illustrates converting GPS coordinates into a string of sequential characters. Location 1310 between San Francisco and San Mateo may represent the current location of an asset associated with an asset tracking device. The GPS coordinates for the asset may correspond to a latitude of 37° 40′ N and to a longitude of 122° 25′ W. Note that GPS coordinates are based on a worldwide system of latitude and longitude. In this example, the geographic region 800 (which may represent a limited region of interest for tracking assets) is limited to a portion of the San Francisco Bay Area. Therefore, the GPS coordinates may need to be translated into a set of geographic region coordinates. The geographic region coordinates may correspond to the number of vertical and horizontal divisions in the grid as previously described. In this example, the X and Y divisions both range from 0 to 7. The corresponding geographic region coordinates for location 1310 are (3, 4).

The next step in translating the location of the asset into a string of sequential characters may be obtaining a binary representation of the geographic region coordinates. In this example, (3, 4) may correspond to binary coordinates of (011, 100). The final step in translating the location of the asset into a string of sequential characters may depend upon the data structure. When using alternating X and Y divisions at each level of the data structure, the binary coordinates may be interleaved to generate a binary string of sequential characters, in this case (011010). Note that each of these characters corresponds to a decision to be made at each level in the data structure previously described, with a “0” representing a traversal to a left child node, and a “1” representing a traversal to a right child node.

Returning to flowchart 1200, the method may additionally include sequentially accessing each character in the string of sequential characters to traverse the data structure (1208). In one embodiment, the first character in the string of sequential characters may be associated with the root node. If the first character in a string of sequential characters is a “0”, then the left child node of the root node may be traversed. Similarly, if the first character in the string of sequential characters is a “1”, then the right child node of the root node may be traversed. In other words, the first character may determine which child node, if any, of the root node should be traversed.

This operation may be repeated for each level of the data structure with each traversal depending upon a successive character in a string of sequential characters. In other words, each successive character in the string of sequential characters may determine which child node, if any, to traverse at each successive level of the data structure. This process may continue until a node is reached that does not have any child nodes associated with it. Alternatively, the traversal process may stop when an indicator is found for a desired zone.

The method may also include determining whether any of the traversed nodes include the identifier associated with the first geographic zone and, in response, executing a set of instructions associated with the first geographic zone (1210). As an example, the location 1310 in FIG. 13 may be used to traverse the data structure 900 in FIG. 10B. Using the string of sequential characters as (011010), this will correspond to a traversal of nodes 910, 912, 918, 928, 930, and 932. Note that although an additional “0” remains in the string of sequential characters, the traversal operation reached node 932, which does not have any child nodes. Therefore, the traversal operation may end. Generally, the traversal operation may end before the end of the string of sequential characters is reached when the current location of the asset is within a rectangular block of a geographic zone that is larger than the smallest possible rectangular block. (In other words, there is no need to traverse the data structure down to a node representing a 1×1 rectangular block if the geographic zone can be optimally represented using larger blocks.)

In determining whether any of the traversed nodes include an identifier associated with a geographic zone, the traversal operation should note that node 932 includes an indicator “A” signifying that the current location is within a geographic zone 810. The traversal operation should also note that node 930 includes an indicator “B” signifying that the current location is also within geographic zone 812. Note that data structure 900 used in this example does not include a representation of geographic zone 814. Therefore, even though the location 1310 is within geographic zone 814, the traversal operation would not determine such unless the data structure 900 were updated to properly represent geographic zone 814.

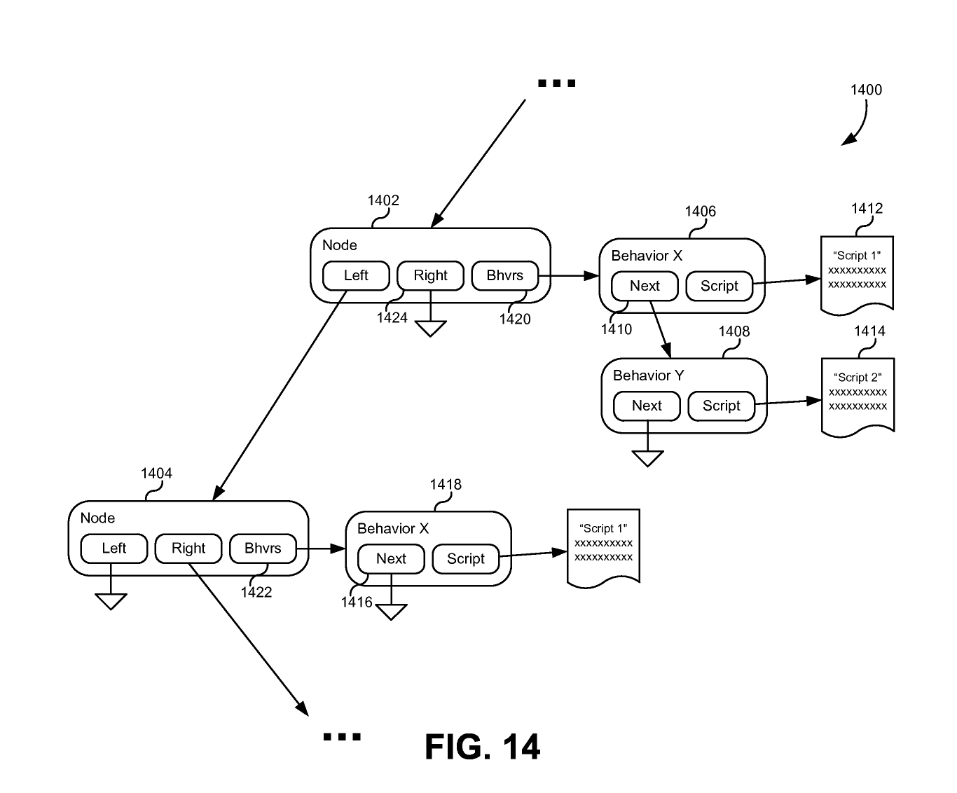

FIG. 14 illustrates an example of traversing a data structure representing multiple geographic zones, according to one embodiment. It may be assumed that additional nodes extend both above and below the boundaries of this diagram. Initially, a traversal operation may enter node 1402, which includes an indication that the asset tracking device is in a particular geographic zone. In this embodiment, the indication is in the form of a behavior pointer 1420 that points to a behavior node 1406. Generally, behavior nodes may be used to indicate particular geographic zones and the actions that should be taken therein. For example, behavior node 1406 may define behavior for asset tracking devices found in geographic zone “X”. A behavior node may also include a script pointer referencing executable code by a processor on an asset tracking device. For example, behavior node 1406 includes a pointer to script 1412 that may be executed when an asset tracking device is located within zone “X”.

It should be noted that more than one behavior may be associated with a single geographic zone. Additionally, a single behavior may be associated with numerous geographic zones. For example, behavior “X” may relate to a wireless communication protocol. This wireless communication protocol may be applied in a number of different geographic zones. Conversely, a first geographic zone may be associated with behavior “X” regulating wireless communications, along with a behavior “Y”, which may control and interval at which various sensors are polled on the asset tracking device. Therefore, the next pointer 1410 in behavior node 1406 may reference behavior node 1408 (behavior “Y”), which in turn may execute script 1414. This may correspond to two different geographic zones, one associated with behavior “X” and one associated with behavior “Y”. Alternatively, this may correspond to a single geographic zone associated with both behavior “X” and behavior “Y”. One advantage of this scheme is the ability to define geographic zones based on the type of behavior desired from the asset tracking device. For example, an asset tracking device may be transported through rough terrain, and a number of behaviors may point to scripts that reduce the sensitivity of accelerometer sensors. As another example, an asset tracking device may be transported through hostile countries, and a number of different behaviors may point to scripts that silence radio communication and any externally visible indications that the asset tracking devices are active. Many different configurations are possible based on the application and environment.

In one embodiment, an asset tracking device may be instructed to determine whether it is any particular geographic zone. For example, an asset tracking device may be instructed to determine whether it is in a geographic zone that is associated with behavior “X”. In this case, the traversal operation may stop at node 1402 because, at this point, the behavior pointer 1422 and behavior node 1406 indicate that the asset tracking device is within a geographic zone associated with behavior “X”. In one embodiment, the data structure may be further optimized by removing any references to behavior “X” that occur in descendants of a node already associated with behavior “X”.

In other embodiments, an asset tracking device may receive a trigger input that instructs it to (1) determine whether it is in one or more geographic zones and (2) execute any behaviors that are associated with the zones. A trigger input may be received from a wireless radio communication, or it may be generated by an interrupt timer on the asset tracking device itself In one embodiment, a trigger input may be generated by a sensor on the asset tracking device. In cases such as these, although the traversal operation may have determined that the asset tracking device is within one or more geographic zones at node 1402, the traversal operation may continue down the tree structure using the next characters in a string of sequential characters to determine whether the asset tracking device is occupying any additional geographic zones.

Continuing with the example of FIG. 14, the traversal operation may access a character “0” in the string of sequential characters and traverse to the left child of node 1402, namely node 1404. Note that if the next character in the string of sequential characters was a “1”, then the traversal operation would end because the right pointer 1424 of node 1402 is null. Node 1404 also includes a non-null behavior pointer 1422 referencing behavior “X” and represented by behavior node 1418. Note that behavior node 1418 may be the same object in memory as behavior node 1406. In this case, the address stored in behavior pointer 1422 would be the same as the address stored in the behavior pointer 1420. At this point, it can be determined that the asset tracking device is within a geographic zone defined by behavior “X” that is distinct from the earlier geographic zone of node 1402. Because the next pointer 1406 of behavior node 1418 is null, only a single behavior is associated with this particular geographic zone.

In one embodiment, each script to be executed is found within the data structure. Thus, each script may be executed before the traversal operation moves onto a subsequent level of the data structure. In another embodiment, pointers to scripts may be stored as they are discovered while traversing the data structure, and executed after the traversal operation is completed. This may be advantageous where the traversal operation is desired to have a predictable power profile and to be executed within a defined period of time. The scripts may also be ordered according to importance or urgency. For example, entering into a first zone may require that a particular script is executed immediately. Thus, the traversal operation may completely traverse the tree, storing scripts pointers as it goes, until it reaches the particular script of the first zone, at which point the particular script may be executed immediately before the traversal continues. Furthermore, after the traversal is complete, the scripts may be reordered according to importance before they are executed.

In one particular embodiment, traversing the data structure may be used to enable geo-casting based on geographic zones. Receiving a radio message may be a trigger event to cause the asset tracking device to initiate the traversal operation of the data structure. Pointers or other forms of indications of geographic zones may be stored during the traversal operation. At the conclusion, the radio message may be ignored or acted upon based on whether or not the tracking device is in one of the targeted geographic zones. This filtering operation may be carried out by a radio module on the asset tracking device and may determine whether or not a main processor needs to be transitioned from a sleep mode into an operating mode. In addition to geo-casting, many other applications and types of processing may be implemented using geographic zones represented by a data structure as described herein. These examples are merely exemplary and not meant to be limiting.

As described above, many of the operations using, defining, and representing geographic zones may be implemented on a computer system. FIG. 15 is a block diagram illustrating components of an exemplary operating environment in which various embodiments of the present invention may be implemented. The system 1500 can include one or more user computers 1505, 1510, which may be used to operate a client, whether a dedicated application, web browser, etc. The user computers 1505, 1510 can be general purpose personal computers (including, merely by way of example, personal computers and/or laptop computers running various versions of Microsoft Corp.'s Windows and/or Apple Corp.'s Macintosh operating systems) and/or workstation computers running any of a variety of commercially-available UNIX or UNIX-like operating systems (including, without limitation, the variety of GNU/Linux operating systems). These user computers 1505, 1510 may also have any of a variety of applications, including one or more development systems, database client and/or server applications, and web browser applications. Alternatively, the user computers 1505, 1510 may be any other electronic device, such as a thin-client computer, Internet-enabled mobile telephone, and/or personal digital assistant, capable of communicating via a network (e.g., the network 1515 described below) and/or displaying and navigating web pages or other types of electronic documents. Although the exemplary system 1500 is shown with two user computers, any number of user computers may be supported.

In some embodiments, the system 1500 may also include a network 1515. The network may be any type of network familiar to those skilled in the art that can support data communications using any of a variety of commercially-available protocols, including without limitation TCP/IP, SNA, IPX, AppleTalk, and the like. Merely by way of example, the network 1515 may be a local area network (“LAN”), such as an Ethernet network, a Token-Ring network and/or the like; a wide-area network; a virtual network, including without limitation a virtual private network (“VPN”); the Internet; an intranet; an extranet; a public switched telephone network (“PSTN”); an infra-red network; a wireless network (e.g., a network operating under any of the IEEE 802.11 suite of protocols, the Bluetooth protocol known in the art, and/or any other wireless protocol); and/or any combination of these and/or other networks such as GSM, GPRS, EDGE, UMTS, 3G, 2.5 G, CDMA, CDMA2000, WCDMA, EVDO etc.

The system may also include one or more server computers 1520, 1525, 1530, which can be general purpose computers and/or specialized server computers (including, merely by way of example, PC servers, UNIX servers, mid-range servers, mainframe computers rack-mounted servers, etc.). One or more of the servers (e.g., 1530) may be dedicated to running applications, such as a business application, a web server, application server, etc. Such servers may be used to process requests from user computers 1505, 1510. The applications can also include any number of applications for controlling access to resources of the servers 1520, 1525, 1530.

The web server can be running an operating system including any of those discussed above, as well as any commercially-available server operating systems. The web server can also run any of a variety of server applications and/or mid-tier applications, including HTTP servers, FTP servers, CGI servers, database servers, Java servers, business applications, and the like. The server(s) also may be one or more computers, which can be capable of executing programs or scripts in response to the user computers 1505, 1510. As one example, a server may execute one or more web applications. The web application may be implemented as one or more scripts or programs written in any programming language, such as Java™, C, C# or C++, and/or any scripting language, such as Perl, Python, or TCL, as well as combinations of any programming/scripting languages. The server(s) may also include database servers, including, without limitation, those commercially available from Oracle®, Microsoft®, Sybase®, IBM® and the like, which can process requests from database clients running on a user computer 1505, 1510.

In some embodiments, an application server may create web pages dynamically for displaying on an end-user (client) system. The web pages created by the web application server may be forwarded to a user computer 1505 via a web server. Similarly, the web server can receive web page requests and/or input data from a user computer and can forward the web page requests and/or input data to an application and/or a database server. Those skilled in the art will recognize that the functions described with respect to various types of servers may be performed by a single server and/or a plurality of specialized servers, depending on implementation-specific needs and parameters.

The system 1500 may also include one or more databases 1535. The database(s) 1535 may reside in a variety of locations. By way of example, a database 1535 may reside on a storage medium local to (and/or resident in) one or more of the computers 1505, 1510, 1515, 1525, 1530. Alternatively, it may be remote from any or all of the computers 1505, 1510, 1515, 1525, 1530, and/or in communication (e.g., via the network 1520) with one or more of these. In a particular set of embodiments, the database 1535 may reside in a storage-area network (“SAN”) familiar to those skilled in the art. Similarly, any necessary files for performing the functions attributed to the computers 1505, 1510, 1515, 1525, 1530 may be stored locally on the respective computer and/or remotely, as appropriate. In one set of embodiments, the database 1535 may be a relational database, such as Oracle 10g, which is adapted to store, update, and retrieve data in response to SQL-formatted commands.

FIG. 16 illustrates an exemplary computer system 1600, in which various embodiments of the present invention may be implemented. The system 1600 may be used to implement any of the computer systems described above. The computer system 1600 is shown comprising hardware elements that may be electrically coupled via a bus 1655. The hardware elements may include one or more central processing units (CPUs) 1605, one or more input devices 1610 (e.g., a mouse, a keyboard, etc.), and one or more output devices 1615 (e.g., a display device, a printer, etc.). The computer system 1600 may also include one or more storage device 1620. By way of example, storage device(s) 1620 may be disk drives, optical storage devices, solid-state storage device such as a random access memory (“RAM”) and/or a read-only memory (“ROM”), which can be programmable, flash-updateable and/or the like.

The computer system 1600 may additionally include a computer-readable storage media reader 1625a, a communications system 1630 (e.g., a modem, a network card (wireless or wired), an infra-red communication device, etc.), and working memory 1640, which may include RAM and ROM devices as described above. In some embodiments, the computer system 1600 may also include a processing acceleration unit 1635, which can include a DSP, a special-purpose processor and/or the like.

The computer-readable storage media reader 1625a can further be connected to a computer-readable storage medium 1625b, together (and, optionally, in combination with storage device(s) 1620) comprehensively representing remote, local, fixed, and/or removable storage devices plus storage media for temporarily and/or more permanently containing computer-readable information. The communications system 1630 may permit data to be exchanged with the network 1620 and/or any other computer described above with respect to the system 1600.

The computer system 1600 may also comprise software elements, shown as being currently located within a working memory 1640, including an operating system 1645 and/or other code 1650, such as an application program (which may be a client application, web browser, mid-tier application, RDBMS, etc.). It should be appreciated that alternate embodiments of a computer system 1600 may have numerous variations from that described above. For example, customized hardware might also be used and/or particular elements might be implemented in hardware, software (including portable software, such as applets), or both. Further, connection to other computing devices such as network input/output devices may be employed. Software of computer system 1600 may include code 1650 for implementing embodiments of the present invention as described herein.

Although embodiments herein frequently are disclosed in the context of sensor networks 140, they are not limited to sensor networks, nor are they limited to transportation or logistical applications. Methods and devices disclosed herein can apply to wireless networks communicating information other than sensor information, such as identification, time, security, and/or location information. Indeed, any number of wireless networks can utilize the features disclosed herein for lower power consumption, predictable and consistent power consumption, and other benefits. Along these lines, the WSDs 110 disclosed herein are not limiting. Network devices utilizing the features disclosed herein, for example, may not gather or transmit sensor data.

In the foregoing description, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-readable instructions, which may be used to cause a machine, such as a general-purpose or special-purpose processor or logic circuits programmed with the instructions to perform the methods. These machine-readable instructions may be stored on one or more machine-readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

While illustrative and presently preferred embodiments of the disclosed systems, methods, and devices have been described in detail herein, it is to be understood that the inventive concepts may be otherwise variously embodied and employed and that the appended claims are intended to be construed to include such variations, except as limited by the prior art.

What is claimed is:

1. A method of creating geographic zones within a geographic region for influencing the operations of one or more asset tracking devices that can be remotely located within the geographic region, the method comprising:
receiving, through an interface, a selection of a first geographic zone located at least partially within the geographic region;
storing a tree data structure that represents the first geographic zone, the tree data structure comprising:
a plurality of nodes, wherein:
each of the plurality of nodes is organized into a plurality of parent-child relationships;
each of the plurality of nodes represents geographic areas, wherein:
a root node in the plurality of nodes represents the geographic region;
each child node in the plurality of parent-child relationships represents a sub-area of a geographic area represented by the respective parent node;
each node in the plurality of nodes represents a geographic area that at least partially overlaps with the first geographic zone; and
each node in the plurality of nodes representing a geographic area that is entirely within the first geographic zone includes an identifier associated with the first geographic zone; and
sending the tree data structure through a port to be stored on the one or more asset tracking devices.

2. The method of claim 1, wherein the tree data structure is optimized such that each node in the plurality of nodes that includes the identifier associated with the first geographic zone is not associated with any child nodes.

3. The method of claim 1, wherein the identifier is associated with one or more sets of instructions for a processor to execute, the processor operating at least one of the one or more asset tracking devices.

4. The method of claim 1, wherein the tree data structure comprises a binary tree.

5. The method of claim 4, wherein each parent node in the plurality of parent-child relationships has two child nodes that equally divide the geographic area represented by the respective parent node.

6. The method of claim 1, further comprising dividing the geographic region into 2^{2N} regions of equal area, wherein N is a positive integer value.

7. The method of claim 1, wherein the first geographic zone is not contiguous.

8. The method of claim 1, wherein a graphical user interface is used to select the first geographic zone from the geographic region.

9. The method of claim 1, further comprising:
receiving, through the interface, a selection of a second geographic zone located at least partially within the geographic region;
adding to the tree data structure:
a second identifier associated with the second geographic zone to each node in the plurality of nodes representing a geographic area that is entirely within the second geographic zone; and
additional nodes that represent a geographic area that at least partially overlaps with the second geographic zone, which do not also partially overlap with the first geographic zone.

10. The method of claim 9, wherein the first geographic zone at least partially overlaps with the second geographic zone.

11. A method of influencing the operations of an asset tracking device within a geographic region based on a location of the asset tracking device relative to a first geographic zone located at least partially within the geographic region, the method comprising:
storing a tree data structure that represents the first geographic zone, the tree data structure comprising:
a plurality of nodes, wherein:
each of the plurality of nodes is organized into a plurality of parent-child relationships;
each of the plurality of nodes represents geographic areas, wherein:
a root node in the plurality of nodes represents the geographic region;
each child node in the plurality of parent-child relationships represents a sub-area of a geographic area represented by the respective parent node;
each node in the plurality of nodes represents a geographic area that at least partially overlaps with the first geographic zone; and
each node in the plurality of nodes representing a geographic area that is entirely within the first geographic zone includes an identifier associated with the first geographic zone;
receiving the location of an asset associated with the asset tracking device;
translating the location of the asset into a string of sequential characters;
sequentially accessing each character in the string of sequential characters to traverse the tree data structure, wherein:
a first character is associated with the root node;
the first character determines which child node, if any, of the root node should be traversed; and
each successive character in the string of sequential characters determines which child node, if any, to traverse at each successive level of the tree data structure; and
determining whether any of the traversed nodes include the identifier associated with the first geographic zone and, in response, executing a set of instructions associated with the first geographic zone.

12. The method of claim 11, wherein the location of the asset comprises a latitude and a longitude.

13. The method of claim 11, wherein translating the location of the asset into the string of sequential characters comprises using a set of X and Y coordinates having 2^{N} divisions in each direction.

14. The method of claim 13, wherein translating the location of the asset into the string of sequential characters further comprises interleaving successive bits from a binary representation of the X and Y coordinates.

15. The method of claim 11, wherein the identifier comprises a link to the set of instructions.

16. The method of claim 11, wherein the tree data structure also represents a second geographic zone by including links to a second set of instructions.

17. The method of claim 11, wherein the set of instructions is associated with a link to a second set of instructions.

18. An asset tracking device for determining whether an asset is located within a first geographic zone at least partially within a geographic region, the system comprising:
a location processing device configured to receive a location of the asset;
a memory storing a tree data structure that represents the first geographic zone, the tree data structure comprising:
a plurality of nodes, wherein:
each of the plurality of nodes is organized into a plurality of parent-child relationships;
each of the plurality of nodes represents geographic areas, wherein:
a root node in the plurality of nodes represents the geographic region;
each child node in the plurality of parent-child relationships represents a sub-area of a geographic area represented by the respective parent node;
each node in the plurality of nodes represents a geographic area that at least partially overlaps with the first geographic zone; and
each node in the plurality of nodes representing a geographic area that is entirely within the first geographic zone includes an identifier associated with the first geographic zone;
a processor coupled to an instruction set, which when executed causes the processor to:
receive the location of an asset associated with the asset tracking device from the location processing device;
translate the location of the asset into a string of sequential characters;
sequentially access each character in the string of sequential characters to traverse the tree data structure, wherein:
a first character is associated with the root node;
the first character determines which child node, if any, of the root node should be traversed; and
each successive character in the string of sequential characters determines which child node, if any, to traverse at each successive level of the tree data structure; and
determine whether any of the traversed nodes include the identifier associated with the first geographic zone and, in response, executing a set of instructions associated with the first geographic zone.

19. The asset tracking device of claim 18, wherein the location processing device comprises a GPS unit.

20. The asset tracking device of claim 18, wherein the instruction set further causes the processor to:
receive a communication comprising an updated data structure, and
replace the tree data structure with the updated data structure in the memory.
